(19) United States
(12) Patent Application Publication
(10) Pub. No.: US 2025/0081201 A1
(43) Pub. Date: Mar. 6, 2025

(54) TERMINAL, RADIO COMMUNICATION METHOD, AND BASE STATION

(71) Applicant: NTT DOCOMO, INC., Tokyo (JP)

(72) Inventors: Hiroki Harada, Tokyo (JP); Shohei Yoshioka, Tokyo (JP); Shinya Kumagai, Tokyo (JP); Satoshi Nagata, Tokyo (JP); Jing Wang, Beijing (CN); Qiping Pi, Beijing (CN)

(73) Assignee: NTT DOCOMO, INC., Tokyo (JP)

(21) Appl. No.: 18/580,476

(22) PCT Filed: Jul. 20, 2021
(86) PCT No.: PCT/JP2021/027175

§ 371 Date: Jan. 18, 2024

(51) Int. Cl. H04W 72/23; H04L 5/00; H04W 72/0446

(52) U.S. Cl. CPC H04W 72/23; H04L 5/0046; H04W 72/0446

(57) ABSTRACT

A terminal according to one aspect of the present disclosure includes a receiving section that receives at least one of configuration information of a pattern of resources unavailable for a DL in certain time resources and indication information related to the pattern of the resources, and a control section that performs control to perform DL reception in resources other than the resources unavailable for the DL, and performs control not to perform the DL reception in the resources unavailable for the DL, based on at least one of the configuration information and the indication information. According to one aspect of the present disclosure, use efficiency of resources can be enhanced.

### DESCRIPTION

### Technical Field

The present disclosure relates to a terminal, a radio communication method, and a base station in next-generation mobile communication systems.

### Background Art

In a Universal Mobile Telecommunications System (UMTS) network, the specifications of Long-Term Evolution (LTE) have been drafted for the purpose of further increasing high speed data rates, providing lower latency and so on (see Non-Patent Literature 1). In addition, for the purpose of further high capacity, advancement and the like of the LTE (Third Generation Partnership Project (3GPP) Release (Rel.) 8 and Rel. 9), the specifications of LTE-Advanced (3GPP Rel. 10 to Rel. 14) have been drafted.

Successor systems of LTE (for example, also referred to as “5th generation mobile communication system (5G),” “5G+ (plus),” “6th generation mobile communication system (6G),” “New Radio (NR),” “3GPP Rel. 15 (or later versions),” and so on) are also under study.

### CITATION LIST

### Non-Patent Literature

Non-Patent Literature 1: 3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8),” April, 2010

### SUMMARY OF INVENTION

### Technical Problem

In future radio communication systems (for example, NR), it is assumed that a plurality of user terminals (User Equipments (UEs)) perform communication under an environment of ultra-high density and high traffic.

Under such an environment, it is assumed that uplink (UL) resources run short, in comparison to downlink (DL) resources.

However, in NR specifications so far, a study on a method of increasing uplink resources has not been fully carried out. Unless the method can be appropriately controlled, this may cause impairment of system performance, such as increase in delay and impairment of coverage performance.

In view of this, the present disclosure has one object to provide a terminal, a radio communication method, and a base station for enhancing use efficiency of resources.

### Solution to Problem

A terminal according to one aspect of the present disclosure includes a receiving section that receives at least one of configuration information of a pattern of resources unavailable for a DL in certain time resources and indication information related to the pattern of the resources, and a control section that performs control to perform DL reception in resources other than the resources unavailable for the DL, and performs control not to perform the DL reception in the resources unavailable for the DL, based on at least one of the configuration information and the indication information.

### Advantageous Effects of Invention

According to one aspect of the present disclosure, use efficiency of resources can be enhanced.

### BRIEF DESCRIPTION OF DRAWINGS

FIG. 1 is a diagram to show an RRC information element “ServingCellConfig”.

FIG. 2 is a diagram to show an RRC information element “PDSCH-Config”.

FIG. 3 is a diagram to show an RRC information element “RateMatchPattern”.

FIGS. 4A and 4B are diagrams to show examples of configuration of a slot structure.

FIG. 5 is a diagram to show an example of a structure of XDD.

FIGS. 6A and 6B are diagrams to show examples of configuration of resources in a time domain and a frequency domain for XDD operation.

FIG. 7 is a diagram to show an example of information elements related to a list of patterns of unavailable resources according to Embodiment 1-1-1.

FIGS. 8A and 8B are diagrams to show examples of application of a pattern of unavailable resources according to Embodiment 1-2-1 and Embodiment 1-2-2.

FIGS. 9A and 9B are diagrams to show examples of application of a pattern of unavailable resources according to Embodiment 2-2.

FIG. 10 is a diagram to show an example of a schematic structure of a radio communication system according to one embodiment.

FIG. 11 is a diagram to show an example of a structure of a base station according to one embodiment.

FIG. 12 is a diagram to show an example of a structure of a user terminal according to one embodiment.

FIG. 13 is a diagram to show an example of a hardware structure of the base station and the user terminal according to one embodiment.

### DESCRIPTION OF EMBODIMENTS

### (TDD Configuration)

In Rel. 15, for the UE, configuration of a UL and a DL (UL resources and DL resources) in time division duplex (TDD) is performed. The UE may receive a higher layer parameter (TDD-UL-DL-ConfigCommon) related to cell-dedicated UL/DL TDD configuration or a higher layer parameter (TDD-UL-DL-ConfigDedicated) related to UE-dedicated UL/DL TDD configuration.

The higher layer parameter (TDD-UL-DL-ConfigCommon) related to cell-dedicated UL/DL TDD configuration includes a parameter (referenceSubcarrierSpacing) for configuring a reference subcarrier spacing and a parameter (TDD-UL-DL-Pattern) related to UL and DL patterns of TDD.

TDD-UL-DL-Pattern includes a parameter (dl-UL-TransmissionPeriodicity) for configuring a period of the DL-UL patterns, a parameter (nrofDownlinkSlots) for configuring the number of consecutive DL slots, a parameter (nrofDownlinkSymbols) for configuring the number of consecutive DL symbols, a parameter (nrofUplinkSlots) for configuring the number of consecutive UL slots, and a parameter (nrofUplinkSymbols) for configuring the number of consecutive UL symbols.

With the higher layer parameter (TDD-UL-DL-ConfigDedicated) related to the UE-dedicated UL/DL TDD configuration, configuration of slots and configuration of slot indexes are performed.

The configuration of slots is performed with a parameter TDD-UL-DL-SlotConfig. TDD-UL-DL-SlotConfig includes a parameter (TDD-UL-DL-SlotIndex) related to slot indexes and a parameter (symbols) related to symbols constituting each slot. The parameter (symbols) related to symbols constituting each slot configures one of a parameter (allDownlink) indicating that the symbols constituting the slot are all used for the DL, a parameter (allUplink) indicating that the symbols constituting the slot are all used for the UL, or a parameter (explicit) explicitly indicating the number of symbols.

The parameter (explicit) explicitly indicating the number of symbols includes a parameter (nrofDownlinkSymbols) for configuring the number of DL symbols and a parameter (nrofUplinkSymbols) for configuring the number of UL symbols.

The UE determines the slot/symbol to be used for at least one of transmission of a UL signal/channel and reception of a DL signal/channel, based on the parameters described above.

### (Rate Match Pattern of PDSCH)

In NR defined in Rel. 16 or previous versions, resource block (RB) symbol-level PDSCH resource mapping is defined for the UE.

The UE determines resources to which the PDSCH is not to be mapped, based on a configured/indicated rate match pattern.

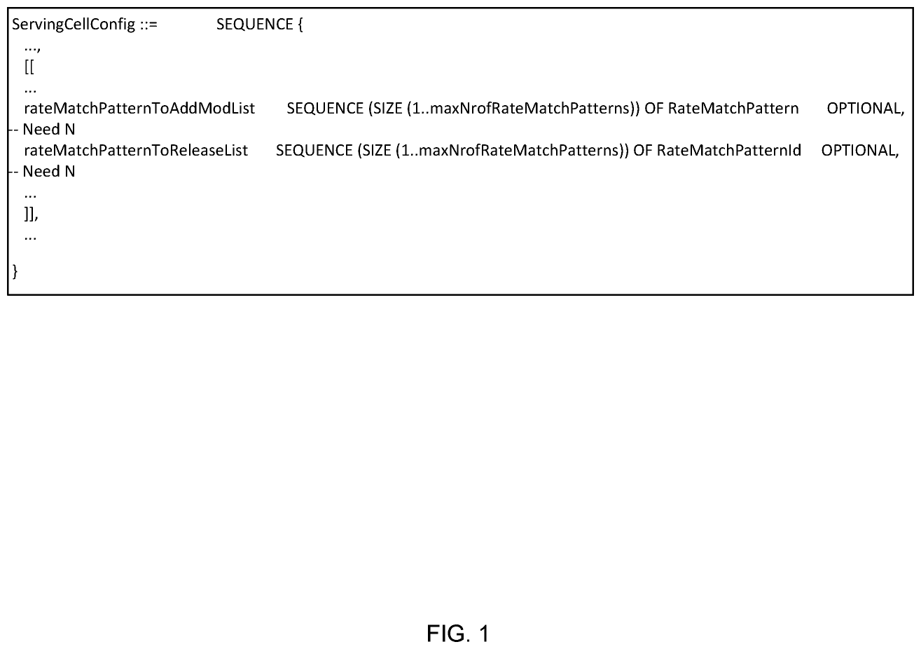

The UE is configured with information related to one list of rate match patterns included in information (for example, an RRC information element “ServingCellConfig”) related to configuration of the serving cell (see FIG. 1). The list includes configuration information (RateMatchPattern) of as many rate match patterns as the number (for example, four) defined with a maximum maxNrofRateMatchPatterns. Each rate match pattern is identified with a rate match pattern ID (RateMatchPatternId).

The UE does not use, for mapping of resources of the PDSCH, a union of unavailable patterns (resources) configured with one or more rate match patterns, which is included in the information related to the list of rate match patterns. In other words, the UE performs rate match of the PDSCH around the union of unavailable patterns (resources) configured with one or more rate match patterns, which is included in the information related to one list of rate match patterns.

As described above, semi-static rate match may mean rate match of the PDSCH based only on higher layer signaling (for example, ServingCellConfig).

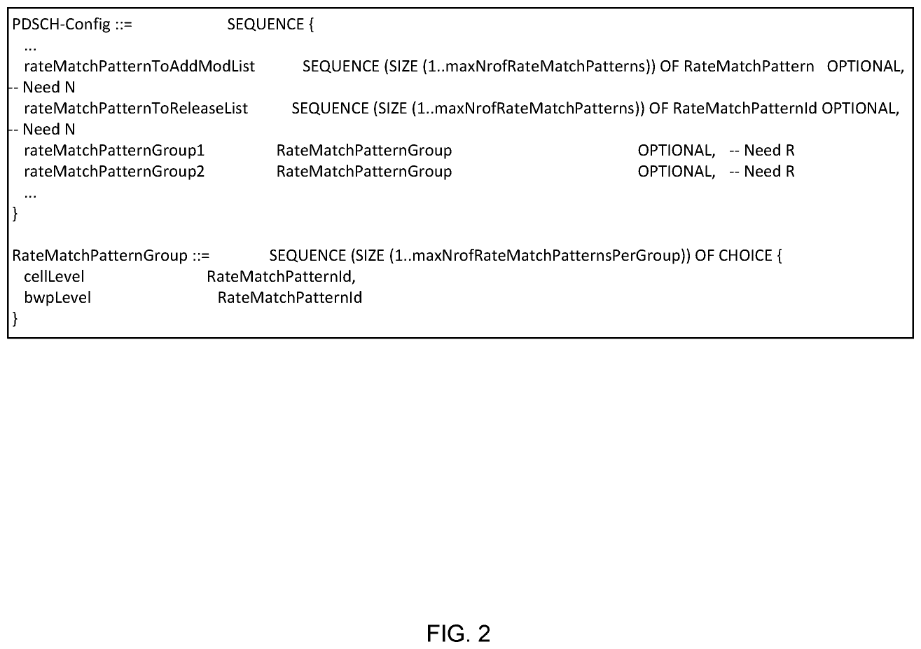

The UE is configured with information related to one list of rate match patterns and information (RateMatchPatternGroup) related to a rate match pattern group, which are included in information (for example, an RRC information element “PDSCH-Config”) related to configuration of a UE-specific PDSCH. The list includes configuration information (RateMatchPattern) of as many rate match patterns as the number (for example, four) defined with the maximum maxNrofRateMatchPatterns (see FIG. 2). Each rate match pattern is identified with a rate match pattern ID (RateMatchPatternId).

Information related to the information (RateMatchPatternGroup) related to the rate match pattern group includes information (rateMatchPatternGroup1) related to a first rate match pattern group and information (rateMatchPatternGroup2) related to a second rate match pattern group.

Each of the information (rateMatchPatternGroup1) related to the first rate match pattern group and the information (rateMatchPatternGroup2) related to the second rate match pattern group includes as many rate match pattern IDs (RateMatchPatternId) as the number (for example, eight) defined with a maximum maxNrofRateMatchPatternsPerGroup.

The rate match pattern IDs (RateMatchPatternId) included in the information (rateMatchPatternGroup1) related to the first rate match pattern group and the information (rateMatchPatternGroup2) related to the second rate match pattern group are associated with one of a cell level (cellLevel) and a BWP level (bwpLevel) (see FIG. 2).

The cell-level (cellLevel) rate match pattern ID (RateMatchPatternId) is associated with the rate match pattern configured in the information (ServingCellConfig) related to configuration of the serving cell. The BWP-level (bwpLevel) rate match pattern ID (RateMatchPatternId) is associated with the rate match pattern configured in the information (PDSCH-Config) related to configuration of the PDSCH.

The UE performs activation of the first rate match pattern group and the second rate match pattern group, based on a field (rate matching indicator) related to the rate match included in a DCI format (for example, DCI format 1_1/1_2) for scheduling the PDSCH.

The number of bits of the field (rate matching indicator) related to the rate match has the number of bits of 0 to 2 bits, according to the number of rate match pattern groups to be configured.

When the UE is configured with the first rate match pattern group and the second rate match pattern group, the UE determines whether to activate the first rate match pattern group based on the most significant bit (MSB) of the field related to the rate match, and determines whether to activate the second rate match pattern group based on the least significant bit (LSB) of the field related to the rate match.

The UE does not use, for mapping of resources of the PDSCH, the union of the unavailable patterns (resources) configured with one or more rate match patterns, which is related to the rate match pattern group to be activated. In other words, the UE performs rate match of the PDSCH around the union of unavailable patterns (resources) configured with one or more rate match patterns, which is related to the rate match pattern group to be activated.

As described above, dynamic rate match may mean rate match of the PDSCH based on higher layer signaling (for example, at least one of ServingCellConfig and PDSCH-Config) and DCI.

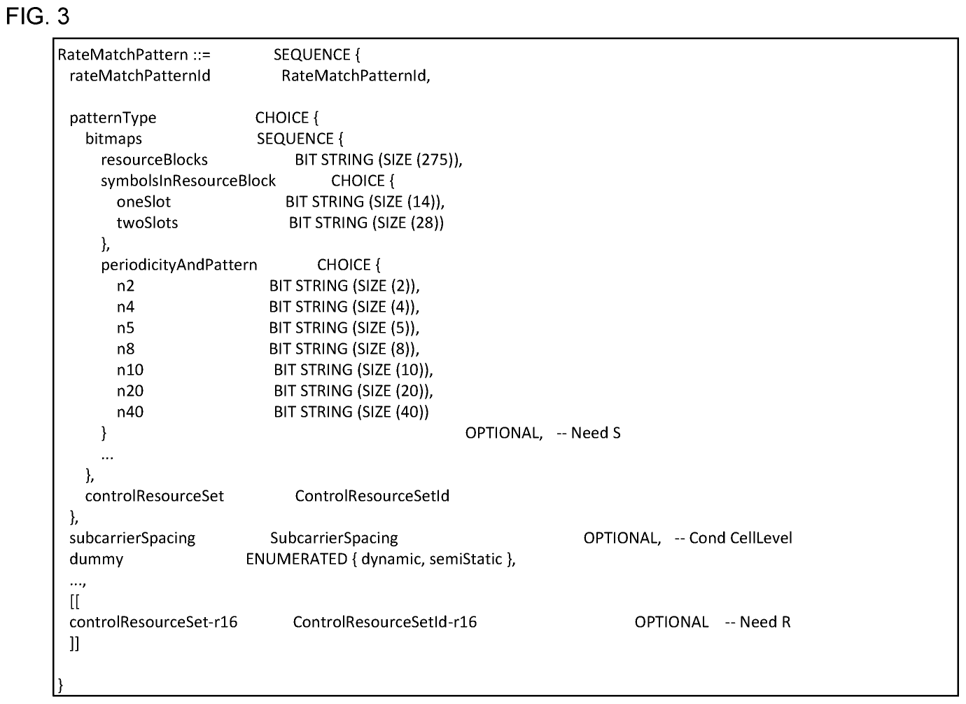

The configuration information (RateMatchPattern) of the rate match pattern includes at least one of information (rateMatchPatternId) related to a rate match pattern ID, information (patternType) related to a pattern type, and information (subcarrierSpacing) related to configuration of a subcarrier spacing (see FIG. 3).

The information (patternType) related to the pattern type includes information related to bitmap information (bitmaps), which includes information (resourceBlocks) related to a resource block, information (symbolsInResourceBlock) related to symbols in the resource block, and information (periodicityAndPattern) related to a period and a pattern, and a CORESET ID.

The information (resourceBlocks) related to the resource block may be a resource block-level bitmap in the frequency domain. The information (symbols InResourceBlock) related to the symbols in the resource block may be a symbol-level bitmap in the time domain.

In each bit of the information (resourceBlocks) related to the resource block, an unavailable frequency position (to which rate match is applied) is configured in the resource block corresponding to the bit indicated with 1. In Rel. 16, with the information (resourceBlocks) related to the resource block, such indication is possible in a range of up to 275 RBs.

In each bit of the information (symbols InResourceBlock) related to the symbols in the resource block, an unavailable time position (to which rate match is applied) is configured in the resource block corresponding to the bit indicated with 1.

The information (symbols InResourceBlock) related to the symbols in the resource block may be a bitmap indicating symbols in one slot, or may be a bitmap indicating symbols in two slots. In other words, in Rel. 16, with the information (resourceBlocks) related to the resource block, such indication is possible in a range of up to two slots (28 symbols).

### (XDD)

LTE of Rel. 14 and previous versions has been put into practical use mainly for frequency division duplex (FDD) while also supporting time division duplex (TDD).

In contrast, NR of Rel. 15 and later versions has been studied mainly for TDD while supporting FDD at the same time (for example, LTE band migration and the like).

In FDD, this is preferable from the viewpoint of reduction of delay because DL reception and UL transmission can be performed simultaneously. In contrast, in FDD, the ratio between DL and UL resources is fixed (for example, 1:1).

In TDD, the ratio between DL and UL resources can be changed. For example, in a general environment where DL traffic is relatively heavy, the DL resource amount can be increased to improve DL throughput.

In contrast, in consideration of a time ratio of transmission and reception in time division duplex (TDD) in Rel. 16 or previous versions, a case with fewer transmission occasions of a UL signal/channel than reception occasions of a DL signal/channel is conceivable. In such a case, there is a concern that the UE cannot perform frequent transmission of a UL signal/channel, which delays transmission of an important UL signal/channel. It is also concerned that, since there are fewer UL transmission occasions than DL reception occasions, signals/channels are congested in the UL transmission occasions. In addition, in TDD, time resources in which a UL signal/channel can be transmitted are restricted. Hence, for example, application of a UL coverage enhancement technique using repetition transmission (Repetition) is also restricted.

For future radio communication systems (for example, Rel. 17/18 or later versions), it is studied to introduce a division duplex method combining TDD and frequency division duplex (FDD) for UL and DL.

The division duplex method may be referred to as an XDD (Cross Division Duplex). XDD may mean a duplex method in which DL and UL are frequency-division-multiplexed (DL and UL can be used simultaneously) in one component carrier (CC) or a plurality of CCs of a TDD band. XDD may mean that, when the duplex method is employed for a plurality of CCs, UL is available, in time resources where DL is available in a certain CC, in another CC. The plurality of CCs may be CCs in the same band.

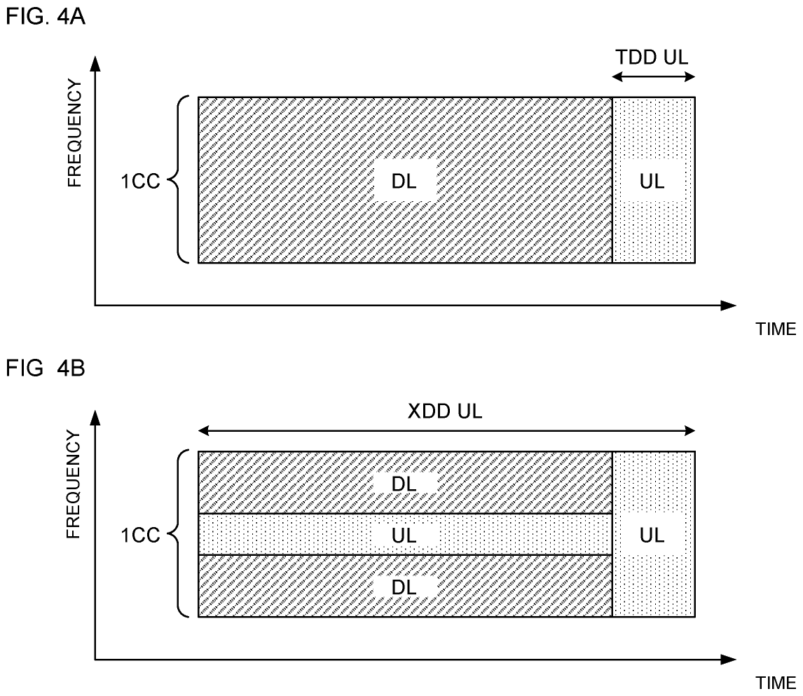

FIG. 4A is a diagram to show an example of a configuration of TDD defined in Rel. 16 or previous versions. In the example shown in FIG. 4A, TDD slots/symbols are configured for a UE in the bandwidth of one component carrier (CC) (which may be referred to as a cell and a serving cell).

In the example shown in FIG. 4A, the time ratio between a DL slot and a UL slot is 4:1. In such an existing slot/symbol configuration in TDD, UL time resources cannot be sufficiently secured, which may cause UL transmission delay and degrade coverage performance.

FIG. 4B is a diagram to show an example of a structure of XDD. In the example of FIG. 4B, resources used for DL reception and resources used for UL transmission overlap in terms of time in one component carrier (CC). With such a structure of resources, it is possible to secure UL resources and consequently improve use efficiency of resources.

For example, as in the example shown in FIG. 4B, by configuring both end resources of the frequency domain in one CC for DL to sandwich UL resources between the DL resources, occurrence of cross link interference (CLI) with neighbor carriers can be prevented and mitigated. A region for guard may be configured at one or more borders between the DL resources and UL resources.

By considering complexity of processing of self-interference, it is conceivable that only a base station uses DL resources and UL resources simultaneously. In other words, it may be configured that a certain UE uses DL resources while another UE uses UL resources in resources where DL and UL overlap in terms of time.

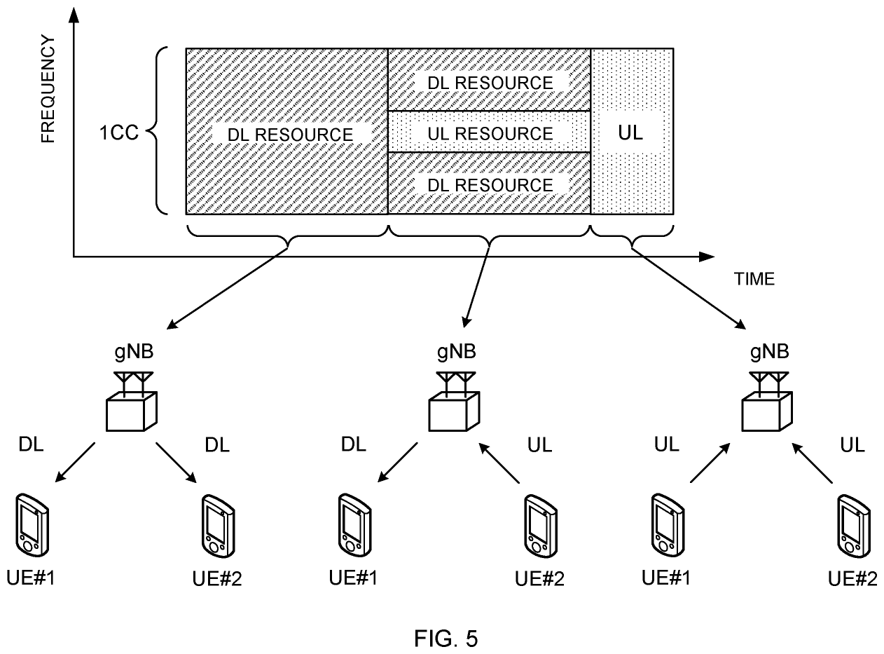

FIG. 5 is a diagram to show an example of a structure of XDD. In the example shown in FIG. 5, it is configured that part of DL resources in a TDD band is allocated as UL resources so that DL and UL partially overlap in terms of time.

In the example shown in FIG. 5, in a period for only DL, each of a plurality of UEs (UE #1 and UE #2 in FIG. 5) receives a DL channel/signal.

In the period where DL and UL overlap in terms of time, a certain UE (UE #1 in the example of FIG. 5) receives a DL channel/signal while another UE (UE #2 in the example of FIG. 5) transmits a UL channel/signal. In this period, a base station performs simultaneous transmission and reception of DL and UL.

Moreover, in a period for UL only, each of a plurality of UEs transmits a UL channel/signal.

In existing NR (for example, those defined in Rel. 15/16 or previous versions), DL frequency resources and UL frequency resources in a carrier for UEs are configured as a DL bandwidth part (BWP) and a UL BWP, respectively. To switch DL/UL frequency resources to other DL/UL frequency resources, a configuration of a plurality of BWPs and a mechanism of adaptation of BWPs are needed.

In existing NR, time resources in a TDD carrier for UEs are configured as at least one of DL, UL, and flexible (FL) in a TDD configuration.

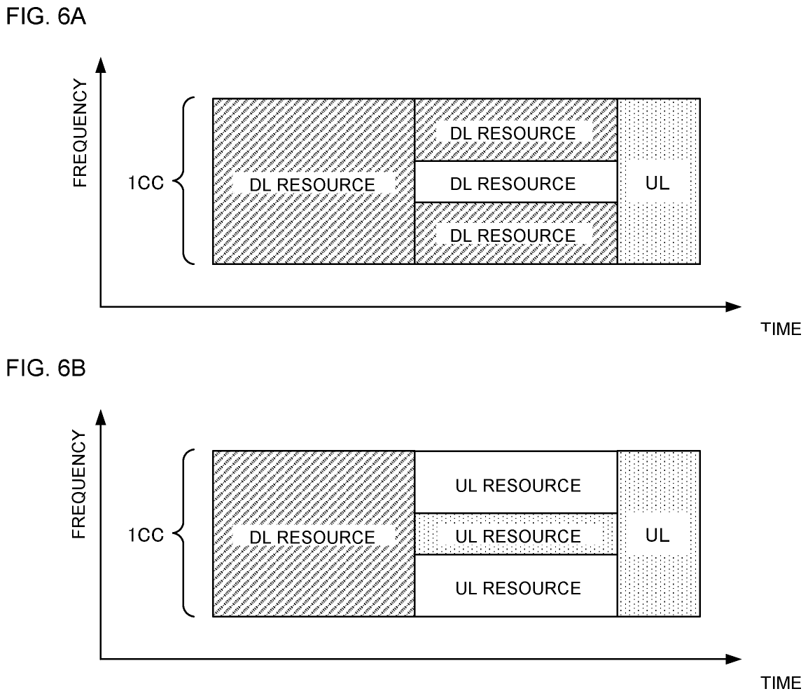

A method of configuring resources in the time domain and the frequency domain for XDD operation has been studied. For example, for UE #1 in FIG. 5, it is conceivable to configure resources in XDD (period where DL an UL overlap) while avoiding use of UL resources corresponding to the part used by other UEs (for example, UE #2) (refer to FIG. 6A).

For example, for UE #2 in FIG. 5, it is conceivable to configure resources in XDD while avoiding use of DL resources corresponding to the part used by other UEs (for example, UE #1) (refer to FIG. 6B).

However, a study on configuration of resources of XDD for the UE has not been fully carried out.

For example, for UE #1 of FIG. 5, time resources of the XDD part are configured as the DL. However, a study on whether to configure frequency resources of the XDD part separately from frequency resources of the DL part (pure DL part) not being the XDD part has not been fully carried out.

The resources unavailable for UE #1 in the XDD part may be used by another UE as the UL, and thus if a DL signal/channel is received in the resources, CLI may occur.

A study is also required on disabling of allocation of DL resources for the resources unavailable for UE #1 in the XDD part. The study should be carried out when, for example, the rest of resources other than the unavailable resources are allocated to one UE or one RS.

In view of this, the following has been under study: when the DL resources in the XDD part and the DL resources not in the XDD part are separately configured/indicated, unavailable resources (for example, rate match patterns) are configured to include the UL part in the XDD part, such that the UE does not perform DL reception in the UL part.

However, the rate match patterns in existing specifications are subject to some restrictions. For example, existing rate match patterns can be applied only to reception of the PDSCH, and one semi-static rate match pattern and two dynamic rate match patterns can be configured.

For example, for UE #2 of FIG. 5, time resources of the XDD part are configured as the UL. However, a study on whether to configure frequency resources of the XDD part separately from frequency resources of the UL part (pure UL part) not being the XDD part has not been fully carried out.

Particularly, it is considered that, in the XDD part, configuration of resources of a specific UL channel/signal (for example, a configured grant PUSCH/PUCCH/SRS/PRACH) is subject to a restriction. In order to transmit the specific UL channel/signal in the UL resources of the XDD part, it is considered that configuration for UL resources in the XDD part and configuration for UL resources not in the XDD part are separately required.

Performing configuration common to both of the UL resources in the XDD part and the UL resources not in the XDD part may be considered, but this limits available UL resources.

When the UL resources in the XDD part and the UL resources not in the XDD part are separately configured for each specific UL channel/signal, signaling overhead increases.

In view of this, in order to reduce signaling overhead, the following has been under study: when the UL resources in the XDD part and the UL resources not in the XDD part are separately configured/indicated, unavailable resources (for example, rate match patterns) are configured to include the DL part in the XDD part, such that the UE does not perform UL transmission in the DL part.

However, a study on how to configure/indicate unavailable resources in the DL/UL has not been fully carried out. Unless a method of configuring/indicating resources is clarified, appropriate transmission and reception cannot be performed, and communication quality/communication throughput may deteriorate.

In view of this, the inventors of the present invention came up with the idea of a method for achieving configuration/indication of resources that does not necessitate change of a BWP/slot format and avoidance of inefficient restrictions in configuration of DL/UL resources.

Embodiments according to the present disclosure will be described in detail with reference to the drawings as follows. The radio communication methods according to respective embodiments may each be employed individually, or may be employed in combination.

### (Radio Communication Method)

The DL signal/channel in the present disclosure may be transmitted using unicast, or may be transmitted using multicast/broadcast for a plurality of UEs. Configuration of the multicast/broadcast/unicast may be performed using higher layer signaling.

In the present disclosure, a channel and a signal may be interchangeably interpreted. In the present disclosure, transmission of a UL channel/signal may be simply referred to as “UL transmission”. In the present disclosure, reception of a DL channel/signal may be simply referred to as “DL reception”.

The UL signal/channel in the present disclosure may be, for example, at least one of an uplink control channel (for example, a PUCCH), an uplink shared channel (for example, a PUSCH), a reference signal for sounding (for example, a sounding reference signal (SRS)), a random access channel (for example, a physical random access channel (PRACH)), a sidelink control channel (for example, a physical sidelink control channel (PSCCH)), a sidelink shared channel (for example, a physical sidelink shared channel (PSSCH)), a sidelink feedback channel (for example, a physical sidelink feedback channel (PSFCH)), a sidelink synchronization signal (for example, a sidelink primary synchronization signal (S-PSS) or a sidelink secondary synchronization signal (S-SSS)), and a sidelink broadcast channel (for example, a physical sidelink broadcast channel (PSBCH)).

The DL signal/channel in the present disclosure may be, for example, at least one of a downlink control channel (for example, a PDCCH), a downlink shared channel (for example, a PDSCH), a channel state information reference signal (CSI-RS), a tracking CSI-RS (Tracking Reference Signal (TRS)), a positioning reference signal (PRS), a synchronization signal block (SSB), a broadcast channel (PBCH), a sidelink control channel (for example, a PSCCH), a sidelink shared channel (for example, a PSSCH), a sidelink feedback channel (for example, a PSFCH), a sidelink synchronization signal (for example, an S-PSS or an S-SSS), and a sidelink broadcast channel (for example, a PSBCH).

In the present disclosure, A/B may mean at least one of A and B. In the present disclosure, “A/B/C” may mean “at least one of A, B, and C”.

In the present disclosure, the higher layer signaling may be, for example, any one or combinations of Radio Resource Control (RRC) signaling, Medium Access Control (MAC) signaling, broadcast information, and the like.

The MAC signaling may use, for example, a MAC control element (MAC CE), a MAC Protocol Data Unit (PDU), or the like. The broadcast information may be, for example, a master information block (MIB), a system information block (SIB), minimum system information (Remaining Minimum System Information (RMSI)), other system information (OSI), or the like.

The physical layer signaling may be downlink control information (DCI), for example.

Note that, in the present disclosure, a port, an antenna, an antenna port, a panel, a beam, an Uplink (UL) transmission entity, a transmission/reception point (TRP), spatial relation information, a spatial relation, a state of a transmission configuration indication (TCI or Transmission Configuration Indicator) (a TCI state (TCI-state)), a quasi-co-location (QCL) assumption, a control resource set (CORESET), a PDSCH, a codeword, a base station, a certain antenna port (for example, a demodulation reference signal (DMRS) port), a certain antenna port group (for example, a DMRS port group), a certain group (for example, a code division multiplexing (CDM) group, a certain reference signal group, a CORESET group, a panel group, a beam group, a spatial relation group, or a PUCCH group), and a CORESET pool may be interchangeably interpreted.

In the present disclosure, reception of a DL signal/channel and transmission of a UL signal/channel may be transmitted and received using the same BWP/CC/band/operating band, or may be transmitted and received using different BWPs/CCs/bands/operating bands.

In the following, in each of the drawings of the present disclosure, a structure in one CC will be described. However, the number of resources in the frequency direction is not limited to this, and a plurality of CCs may be used. In other words, XDD may be employed within a carrier (Intra-carrier), or may be employed among carriers (a plurality of carriers, Inter-carrier).

In the present disclosure, a BWP, a CC, a cell, a serving cell, a band, a carrier, an operating band, a physical resource block group (PRG), a PRB, an RB, an RE, and a resource may be interchangeably interpreted.

In the present disclosure, “A and B overlap”, “A and B overlap”, and “at least a part of A overlaps at least a part of B” may be interchangeably interpreted.

Note that each embodiment of the present disclosure may be applied under a condition of at least one of a case in which the UE reports a UE capability corresponding to at least one function/capability in each embodiment to a NW and a case in which a UE capability corresponding to at least one function/capability in each embodiment is configured/activated/indicated for the UE via higher layer signaling. Each embodiment of the present disclosure may be applied in a case in which a specific higher layer parameter is configured/activated/indicated for the UE.

In the present disclosure, a time domain (period/part) in which DL resources and UL resources in a certain number of CCs of a TDD band are simultaneously available, an XDD part, an XDD period, an XDD structure, a first DL/UL part, a first period, a period in which DL reception/UL transmission is limited, a period in which the DL and the UL coexist, a period in which UL transmission can be performed in a DL period, and a period in which an unavailable resource may be configured/indicated may be interchangeably interpreted.

The DL/UL resource in the XDD part may be interchangeably interpreted as an XDD DL/UL resource, an XDD DL/UL, a first DL/UL resource, a first DL/UL part, a DL/UL resource in which an unavailable resource may be configured/indicated, and a DL/UL part in which an unavailable resource may be configured/indicated.

The DL/UL resource in which the DL and the UL of the TDD band do not overlap in terms of time may be interchangeably interpreted as a non-XDD DL/UL resource, a pure DL/UL resource, a DL/UL resource of other than XDD, a second DL/UL resource, a second DL/UL part, a DL/UL resource in which an unavailable resource is not configured/indicated, a DL/UL part in which an unavailable resource is not configured/indicated, a second period, or the like.

The XDD operation may indicate operation in a period in which the XDD DL/UL resources are configured, or may indicate overall operation of TDD in which XDD may be used.

In the present disclosure, a DL/UL BWP in a TDD band, a DL/UL BWP defined before Rel. 15/16, and a normal DL/UL BWP may be interchangeably interpreted.

In the present disclosure, the XDD part may mean at least one of the time resources used when UL resources are configured in the same time resources as DL resources and the time resources used when DL resources are configured in the same time resources as UL resources. The XDD part may mean at least one of the time resources used when FL resources (resources available for the DL and the UL) are configured in the same time resources as DL resources and the time resources used when FL resources (resources available for the DL and the UL) are configured in the same time resources as UL resources.

In the present disclosure, information, configuration information, indication information, an information element, a parameter, a field, and a code point may be interchangeably interpreted. In the present disclosure, configuration information, an RRC information element, an RRC parameter, a higher layer parameter, and higher layer signaling may be interchangeably interpreted.

In the present disclosure, drop, stop, cancel, puncture, rate match, postpone, and the like may be interchangeably interpreted.

In the present disclosure, an unavailable resource, a pattern of unavailable resources, a non-available resource, a pattern of non-available resources, an unused resource, a pattern of unused resources, a rate match pattern, a rate matching pattern, a puncture pattern, a puncturing pattern, a muting resource pattern, an invalid resource, an invalid resource pattern, and the like may be interchangeably interpreted.

Each embodiment of the present disclosure can be applied not only to a case in which XDD is used. In other words, each embodiment of the present disclosure can also be applied to a case in which TDD/FDD is applied, and use of XDD is not necessarily required.

### First Embodiment

A first embodiment will describe configuration/indication/activation of DL resources.

### Embodiment 1-1

In Embodiment 1-1, the UE may be configured/indicated with resources unavailable for the DL, based on higher layer signaling, physical layer signaling, and a combination of those.

### Embodiment 1-1-1

For example, the UE may be configured with resources unavailable for the DL, based on a specific RRC parameter.

For example, the specific RRC parameter may be included in the information related to the configuration of the serving cell. The information related to the configuration of the serving cell may be at least one of information (for example, ServingCellConfig) related to configuration of the serving cell specific to a UE and information (for example, ServingCellConfigCommon) related to configuration of the serving cell common to a plurality of UEs.

The specific RRC parameter may be information of a list including one or more patterns of unavailable resources, for example.

For example, the information related to the configuration of the serving cell may include at least one of information of a list for adding/changing a pattern of unavailable resources, information of a list for releasing a pattern of unavailable resources, and information related to a group of patterns of unavailable resources.

The list may include information of a pattern of a certain maximum number of unavailable resources. The certain number may be defined in a specification in advance.

In the present disclosure, the information related to the list of patterns of unavailable resources may mean at least one of the information of the list for adding/changing the pattern of unavailable resources, the information of the list for releasing the pattern of unavailable resources, and the information related to the group of patterns of unavailable resources. Information related to a list of rate match patterns of the PDSCH may mean at least one of information of a list for adding/changing a rate match pattern of the PDSCH, information of a list for releasing a rate match pattern of the PDSCH, and information related to a group of a rate match pattern of the PDSCH.

The information related to the group of patterns of unavailable resources may be configured regarding a plurality of (for example, two) groups. For example, the information related to the configuration of the serving cell may include information related to a first group of patterns of unavailable resources and information related to a second group of patterns of unavailable resources.

Note that the present disclosure will describe a case in which the number of groups is two, but the number of groups may be three or more. The number of groups may be defined in a specification in advance, may be configured for the UE using higher layer signaling, or may be determined based on a UE capability.

The information related to the group of patterns of unavailable resources may correspond to a specific frequency resource level. For example, the information related to the group of patterns of unavailable resources may correspond to one of a cell level and a BWP level.

The UE may determine the resources unavailable for the DL, based on the union of one or more patterns (resources) included in the list.

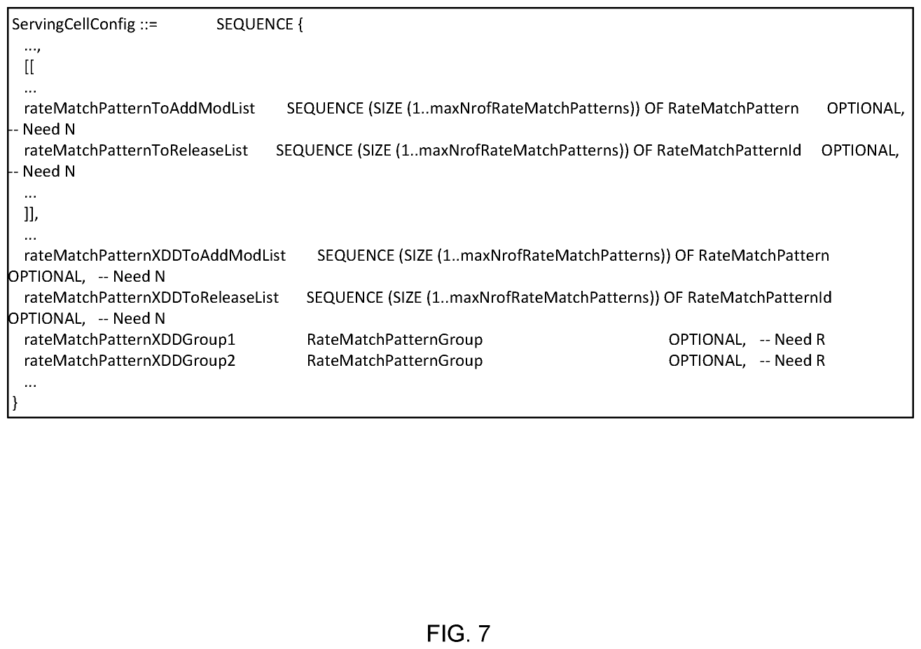

FIG. 7 is a diagram to show an example of information elements related to a list of patterns of unavailable resources according to Embodiment 1-1-1. In the example shown in FIG. 7, ServingCellConfig includes information (rateMatchPatternXDDToAddModList) of a list for adding/changing a pattern of unavailable resources and information (rateMatchPatternXDDToReleaseList) of a list for releasing a pattern of unavailable resources, and the information related to the configuration of the serving cell includes information (rateMatchPatternXDDGroup1) related to a first group of patterns of unavailable resources and information (rateMatchPatternXDDGroup2) related to a second group of patterns of unavailable resources.

As configuration information of a pattern of unavailable resources, an RRC information element (for example, RateMatchPattern) used for rate match of the PDSCH may be used (see FIG. 2).

Note that bit sizes and terms of the parameters in each embodiment of the present disclosure are merely examples, and are not limited to the described examples.

The configuration information of the pattern of unavailable resources may be a new RRC information element/parameter to be defined in Rel. 17 or later versions.

### Embodiment 1-1-2

For example, the UE may be indicated with resources unavailable for the DL in the XDD part, based on a specific RRC parameter and a specific indication information/indicator.

The specific RRC parameter may be at least one of the parameters described in Embodiment 1-1-1 above.

The specific indication information/indicator may be notified to the UE, using at least one of a MAC CE and DCI.

For example, the specific indication information/indicator may be a specific field included in a specific DCI format. The specific DCI format may be a DCI format (for example, DCI format 1_1/1_2) for scheduling the PDSCH, or may be another DCI format.

For example, the number of bits of the specific indication information/indicator may be determined based on the number of groups of patterns of unavailable resources. For example, the number of bits of the specific indication information/indicator may be common to the number of groups of patterns of unavailable resources. In this case, the specific indication information/indicator may be configured as a bitmap in which an N-th bit of the specific indication information/indicator corresponds to an N-th group of patterns of unavailable resources.

According to Embodiment 1-1, the resources unavailable for the DL can be appropriately configured/indicated for the UE, using at least one of higher layer signaling and physical layer signaling.

### Embodiment 1-2

The resources available for the UL may be configured/indicated based on configuration/indication of the resources unavailable for the DL.

The resources unavailable for the DL and the resources available for the UL may be the same time and frequency resources. The resources available for the UL may be configured/indicated to be included in the same time and frequency resources as the resources unavailable for the DL.

Configuration/indication of the resources unavailable for the DL may be performed in addition to/instead of existing configuration/indication of the rate match pattern of the PDSCH. Configuration/indication of the resources unavailable for the DL may be semi-statically/dynamically performed.

Semi-static configuration of the resources unavailable for the DL may mean configuration of the resources unavailable for the DL based on higher layer signaling. Dynamic configuration of the resources unavailable for the DL may mean configuration of the resources unavailable for the DL based on higher layer signaling and physical layer signaling (DCI).

### Embodiment 1-2-1

Embodiment 1-2-1 will describe configuration of the resources unavailable for the DL based on higher layer signaling.

For the UE, configuration of the resources unavailable for the DL may be performed in common to configuration of the rate match pattern of the PDSCH (Embodiment 1-2-1-1).

For example, the number of bits of the parameter related to the rate match pattern of the PDSCH and the number of bits of the parameter related to the pattern of unavailable resources may be the same.

For example, the number of rate match patterns included in the list related to the rate match pattern of the PDSCH and the number of patterns included in the list related to the pattern of unavailable resources may be the same.

For example, granularity of resources indicated by the rate match pattern of the PDSCH and granularity of resources indicated by the pattern of unavailable resources may be the same. The granularity of resources may be configured for each specific frequency resource and for each specific time resource. For example, the granularity of resources may be configured for each RB and for each symbol.

For example, a range of resources indicated by the rate match pattern of the PDSCH and a range of resources indicated by the pattern of unavailable resources may be the same. The range of resources may be at least one of the number of a certain maximum number of frequency resources that can be indicated and the number of a certain maximum number of time resources that can be indicated. For example, the number of the certain maximum number of frequency resources that can be indicated may be 275 RBs. The number of the certain maximum number of time resources that can be indicated may be two slots (28 symbols).

For the UE, configuration of the resources unavailable for the DL may be performed separately from configuration of the rate match pattern of the PDSCH (Embodiment 1-2-1-2).

For example, the number of bits of the parameter related to the rate match pattern of the PDSCH and the number of bits of the parameter related to the pattern of unavailable resources may be separately configured/defined.

For example, the number of rate match patterns included in the list related to the rate match pattern of the PDSCH and the number of patterns included in the list related to the pattern of unavailable resources may be separately configured. For example, different configurations of the number of rate match patterns included in the list related to the rate match pattern of the PDSCH and the number of patterns included in the list related to the pattern of unavailable resources may be supported.

For example, granularity of resources indicated by the rate match pattern of the PDSCH and granularity of resources indicated by the pattern of unavailable resources may be separately defined. The granularity of resources may be configured for each specific frequency resource and for each specific time resource. For example, the granularity of resources may be configured for each RB and for each symbol.

For example, a range of resources indicated by the rate match pattern of the PDSCH and a range of resources indicated by the pattern of unavailable resources may be separately defined. The range of resources may be at least one of the number of a certain maximum number of frequency resources that can be indicated and the number of a certain maximum number of time resources that can be indicated. For example, regarding the resources indicated by the pattern of unavailable resources, the number of the certain maximum number of frequency resources that can be indicated may be larger (or smaller) than 275 RBs. The number of the certain maximum number of time resources that can be indicated may be larger (or smaller) than two slots (28 symbols).

For the UE, at least one of the information of the list for adding/changing the pattern of unavailable resources, the information of the list for releasing the pattern of unavailable resources, and the information related to the group of patterns of unavailable resources may be configured separately from the information related to the list of the rate match patterns of the PDSCH. One or more lists related to the pattern of unavailable resources may be configured.

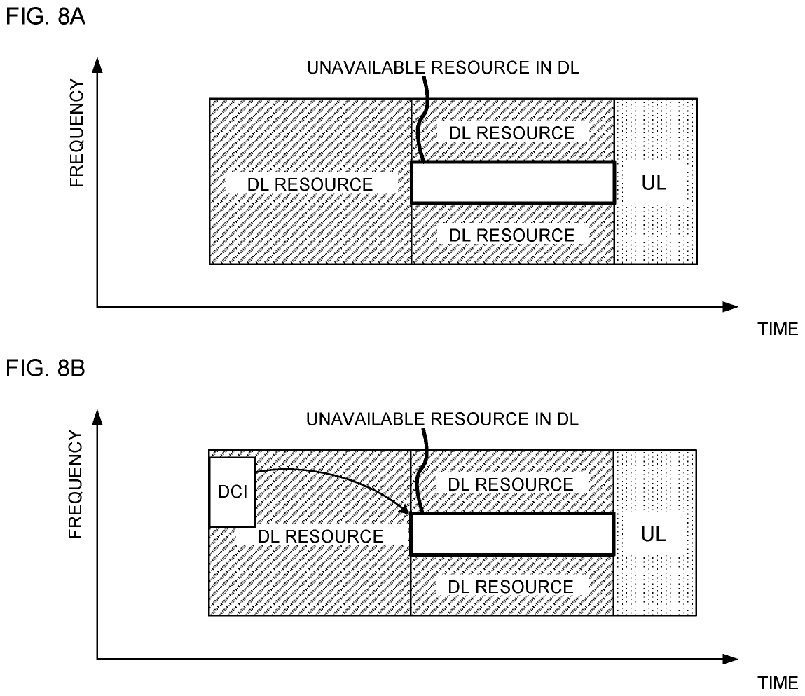

FIG. 8A is a diagram to show an example of application of a pattern of unavailable resources according to Embodiment 1-2-1. In the example shown in FIG. 8A, the pattern of the resources unavailable for the DL configured using higher layer signaling is applied.

### Embodiment 1-2-2

Embodiment 1-2-2 will describe configuration/indication of the resources unavailable for the DL based on higher layer signaling and physical layer signaling (DCI).

In Embodiment 1-2-2, regarding configuration of the resources unavailable for the DL using higher layer signaling for the UE, at least one of the methods described in Embodiment 1-2-1 above may be applied.

The UE may determine indication/activation of the resources unavailable for the DL, using a specific field included in DCI (for example, DCI format 1_0/1_1/1_2) for scheduling DL transmission (Embodiment 1-2-2-1).

The specific field may be a field different from a field related to rate match of the PDSCH.

The specific field may be a field for enabling (or disabling) or activating the configured pattern of the resources unavailable for the DL. In this case, the specific field may include a certain number of bits. The certain number may be common to the number of groups of patterns of unavailable resources configured using higher layer signaling.

The UE may determine indication/activation of the resources unavailable for the DL, using the specific field included in a DCI format other than the DCI for scheduling DL transmission (Embodiment 1-2-2-2). The DCI format may be, for example, a (group-common) DCI format common to a plurality of terminals. The (group-common) DCI format common to a plurality of terminals can be preferably applied to a case in which the pattern of unavailable resources is applied to reception of a channel/signal other than the PDSCH.

The UE may determine indication/activation of the resources unavailable for the DL, based on at least one of a radio network temporary identifier (RNTI), a sequence, a reference signal sequence, and a format to be applied to the DL channel/signal (Embodiment 1-2-2-3).

The UE may determine activation/deactivation of the resources unavailable for the DL, based on the specific field included in a specific MAC CE (Embodiment 1-2-2-4).

FIG. 8B is a diagram to show an example of application of a pattern of unavailable resources according to Embodiment 1-2-2. In the example shown in FIG. 8B, the pattern of the resources unavailable for the DL configured/indicated using higher layer signaling and DCI is applied.

According to Embodiment 1-2, the resources unavailable for the DL can be appropriately configured/indicated/activated for the UE, using at least one of higher layer signaling and physical layer signaling.

### Embodiment 1-3

Embodiment 1-3 will describe a DL channel/signal to which configuration/indication of the resources unavailable for the DL is applied.

The DL channel/signal to which configuration/indication of the resources unavailable for the DL is applied may be at least one of the following channels/signals:
PDSCH.
PDCCH.
CSI-RS.
Tracking CSI-RS (Tracking Reference Signal (TRS)).
Positioning reference signal (PRS).
SSB.
Physical sidelink control channel (PSCCH).
Physical sidelink shared channel (PSSCH).
Physical sidelink feedback channel (PSFCH).
Sidelink synchronization signal (for example, a sidelink primary synchronization signal (S-PSS) or a sidelink secondary synchronization signal (S-SSS)).
Physical sidelink broadcast channel (PSBCH).

For example, configuration/indication of the resources unavailable for the DL may be applied only to the PDSCH (Embodiment 1-3-1).

In Embodiment 1-3-1, the UE need not assume that reception of a DL channel/signal other than the PDSCH is scheduled in the configured/indicated resources unavailable for the DL (resources available for the UL).

In Embodiment 1-3-1, when scheduling of the PDSCH is performed in unavailable resources, the UE may rate match the PDSCH around the resources.

In Embodiment 1-3-1, the UE may conform to configuration/indication of reception of a DL channel/signal other than the PDSCH.

For example, configuration/indication of the resources unavailable for the DL may be applied to a DL channel/signal (hereinafter referred to as another DL channel/signal) other than the PDSCH and the PDSCH (Embodiment 1-3-2).

In Embodiment 1-3-2, when configuration/indication/activation of the resources unavailable for the DL is performed for the UE and the resources and another DL channel/signal overlap, the UE need not perform reception of such another DL channel/signal (Embodiment 1-3-2-1).

In Embodiment 1-3-2, when configuration/indication/activation of the resources unavailable for the DL is performed for the UE and the resources and another DL channel/signal overlap, the UE may rate match/puncture such another DL channel/signal around the resources (Embodiment 1-3-2-2).

Note that, in Embodiment 1-3, different configuration/indication/activation of unavailable resources may be performed separately for each different channel/signal. For example, different rate matching patterns/puncturing patterns may be configured/indicated for different channels/signals.

According to Embodiment 1-3, the resources unavailable for the DL can also be appropriately applied to a channel/signal other than the PDSCH in addition to the PDSCH.

### Embodiment 1-4

UE capability information indicating support of the functions/features described in at least one of Embodiments 1-1 to 1-3 above may be defined. The UE may report the UE capability information to a network (for example, the base station).

The capability information may be reported for each UE, may be reported for each frequency range, may be reported for each band, may be reported for each feature set (FS) (for each band in a combination unit of a plurality of bands), or may be reported for each cell in an FS unit (for each CC of each band in a combination unit of a plurality of bands).

The capability information may be defined only for TDD, may be defined for FDD and TDD, or may be defined separately for FDD and TDD.

According to the UE capabilities/higher layer parameters described above, the UE can implement the above functions while maintaining compatibility with existing specifications.

According to the first embodiment described above, resources can be appropriately configured/indicated/activated for the DL.

### Second Embodiment

A second embodiment will describe configuration/indication of UL resources.

### Embodiment 2-1

In the UL in a period (first period) in which resources unavailable for the UL may be configured/indicated and the UL in a period (second period) in which resources unavailable for the UL are not configured/indicated, configuration of a UL channel/signal may be separately performed.

In the present disclosure, the resources unavailable for the UL may mean resources unavailable for a specific type of UL transmission.

For example, in addition to existing configuration of a UL channel/signal, configuration of a UL channel/signal in the UL in the second period may be performed.

For example, a maximum number of resources that can be configured in the existing configuration of a UL channel/signal may be added.

For example, a plurality of (for example, two) different frequency domain resource allocation (FDRA) configurations may be set for the UE regarding one configured grant PUSCH, and indication/change may be semi-statically/dynamically performed using higher layer signaling/DCI. For example, of the two configurations, one may be applied to the configured grant PUSCH in the UL in the first period, and the other may be applied to the configured grant PUSCH in the UL in the second period. For example, the UE may perform the indication/change, based on at least one of a structure/pattern of XDD and an indication as to whether or not the change (switching) is to be performed.

Note that, in the present disclosure, the configured grant PUSCH may mean the PUSCH that is semi-statically scheduled using only higher layer signaling or using higher layer signaling and physical layer signaling. For example, the PUSCH semi-statically scheduled using higher layer signaling may be a configured grant type 1 PUSCH. For example, the PUSCH semi-statically scheduled using higher layer signaling and physical layer signaling may be a configured grant type 2 PUSCH.

For example, PUCCH resources/resource set in the first period and PUCCH resources/resource set in the second period may be separately configured.

For example, a plurality of PUCCH resources/resource sets may be configured, and selection/determination of the PUCCH resources/resource set may be performed based on semi-static/dynamic configuration/indication using higher layer signaling/DCI. The semi-static/dynamic configuration/indication using higher layer signaling/DCI may be performed based on at least one of a structure/pattern of XDD, a pattern of PUCCH resources, and a PUCCH resource indicator, for example.

For example, SRS resources/resource set in the first period and SRS resources/resource set in the second period may be separately configured.

For example, a plurality of SRS resources/resource sets may be configured, and selection/determination of the SRS resources/resource set may be performed based on semi-static/dynamic configuration/indication using higher layer signaling (for example, RRC signaling/MAC CE)/DCI. The semi-static/dynamic configuration/indication using higher layer signaling/DCI may be performed based on at least one of a structure/pattern of XDD, a pattern of SRS resources, and an SRS resource indicator, for example.

For example, configuration of the PRACH in the first period and configuration of the PRACH in the second period may be separately performed.

According to Embodiment 2-1, even when a period in which resources unavailable for the UL may be configured/indicated and a period in which resources unavailable for the UL are not configured/indicated are configured, configuration of a UL channel/signal can be appropriately performed.

### Embodiment 2-2

In Embodiment 2-2, the UE may be configured/indicated/activated with resources unavailable for the UL, based on higher layer signaling, physical layer signaling, and a combination of those.

Regarding a method of configuration/indication/activation of the resources unavailable for the UL for the UE, at least one of the methods described in Embodiments 1-1 and 1-2 above may be applied, with the “DL” being replaced with the “UL” and the “UL” being replaced with the “DL”.

The resources available for the DL may be configured/indicated based on configuration/indication of the resources unavailable for the UL.

The resources unavailable for the UL and the resources available for the DL may be the same time and frequency resources. The resources available for the DL may be configured/indicated to be included in the same time and frequency resources as the resources unavailable for the UL.

Configuration/indication of the resources unavailable for the UL may be performed in addition to/instead of existing configuration/indication of the rate match pattern of the PDSCH. Configuration/indication of the resources unavailable for the UL may be semi-statically/dynamically performed.

For example, configuration/indication of the resources unavailable for the UL may be performed using at least one of higher layer signaling (for example, RRC signaling/MAC CE) and physical layer signaling (for example, DCI). The DCI may be at least one of DCI for scheduling a UL/DL channel/signal and (group-common) DCI common to a plurality of UEs.

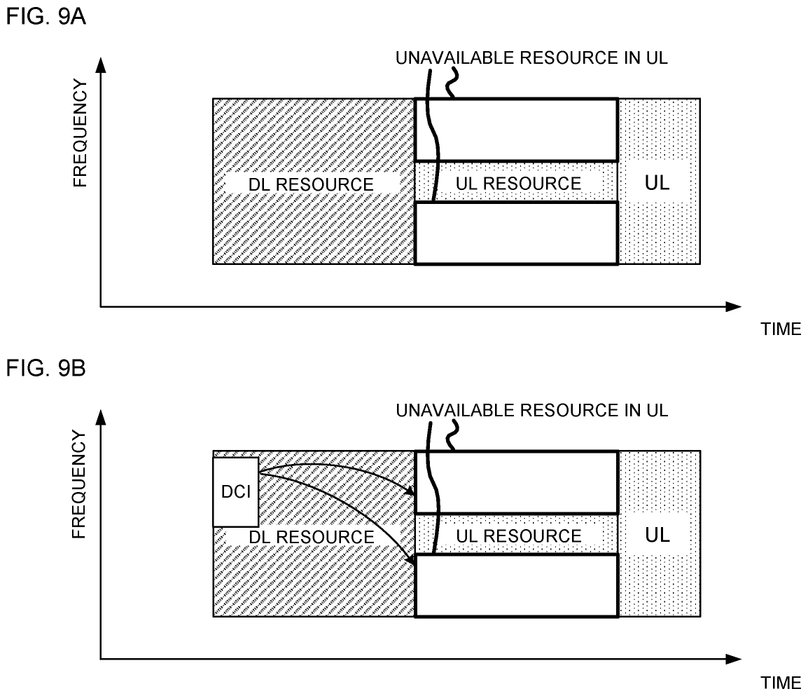

FIG. 9A is a diagram to show an example of application of a pattern of unavailable resources according to Embodiment 2-2. In the example shown in FIG. 9A, the pattern of the resources unavailable for the UL configured using higher layer signaling is applied.

FIG. 9B is a diagram to show another example of application of a pattern of unavailable resources according to Embodiment 2-2. In the example shown in FIG. 9B, the pattern of the resources unavailable for the UL configured/indicated using higher layer signaling and DCI is applied.

The pattern of the resources unavailable for the UL may be configured/indicated in addition to configuration/indication of the pattern of the resources unavailable for the DL. In other words, the pattern of the resources unavailable for the UL may be configured/indicated separately from the configuration/indication of the pattern of the resources unavailable for the DL.

The pattern of the resources unavailable for the UL may be configured/indicated together with the configuration/indication of the pattern of the resources unavailable for the DL. For example, higher layer parameters for configuring the pattern of the resources unavailable for the UL and the pattern of the resources unavailable for the DL may be included in a common information element. DCIs for indicating the pattern of the resources unavailable for the UL and the pattern of the resources unavailable for the DL may be DCIs common to a plurality of UEs.

The pattern of the resources unavailable for the UL may be applied to a specific UL channel/signal. The specific channel may be at least one of the PUSCH, the configured grant PUSCH, the PUCCH, the SRS, and the PRACH scheduled using DCI.

The specific channel may be a UL channel/signal other than the PUSCH scheduled using DCI. The UE may assume not to apply the pattern of the resources unavailable for the UL to the PUSCH scheduled using DCI.

Note that, in Embodiment 2-2, different configuration/indication/activation of unavailable resources may be performed separately for each different channel/signal. For example, different rate matching patterns/puncturing patterns may be configured/indicated for different channels/signals.

According to Embodiment 2-2, the resources unavailable for the UL for a plurality of UL channels/signals can be appropriately configured/indicated.

### Embodiment 2-3

UE capability information indicating support of the functions/features described in at least one of Embodiments 2-1 and 2-2 above may be defined. The UE may report the UE capability information to a network (for example, the base station).

The capability information may be reported for each UE, may be reported for each frequency range, may be reported for each band, may be reported for each feature set (FS) (for each band in a combination unit of a plurality of bands), or may be reported for each cell in an FS unit (for each CC of each band in a combination unit of a plurality of bands).

The capability information may be defined only for TDD, may be defined for FDD and TDD, or may be defined separately for FDD and TDD.

Capability information related to the first embodiment (for example, capability information related to the resources unavailable for the DL) and capability information related to the second embodiment (for example, capability information related to the resources unavailable for the UL) may be configured in common, or may be configured separately.

According to the UE capabilities/higher layer parameters described above, the UE can implement the above functions while maintaining compatibility with existing specifications.

### Embodiment 2-4

When transmission of a UL channel/signal is scheduled/triggered using DCI, the pattern of the resources available for the UL may be configured using only higher layer signaling.

When transmission of a UL channel/signal is scheduled/triggered using DCI, the pattern of the resources available for the UL may be indicated using the scheduling/triggering DCI.

When transmission of a UL channel/signal is configured using higher layer signaling, the pattern of the resources available for the UL may be configured using only higher layer signaling. The UL channel/signal configured using higher layer signaling may be, for example, at least one of periodic UL transmission (for example, an SRS), semi-persistently scheduled UL transmission, UL transmission of a configured grant (for example, a PUSCH), and repetition transmission (for example, a PUSCH/PUCCH).

Note that the “UL” in Embodiment 2-4 may be replaced with the “DL” as appropriate. Application to the first embodiment may be possible with the “UL” in Embodiment 2-4 being replaced with the “DL”.

According to Embodiment 2-4, for example, even when the resources available for the UL are dynamically indicated and the UE fails to detect the indication, transmission and reception in unavailable resources can be prevented, and occurrence of CLI can be avoided.

According to the second embodiment described above, the resources unavailable for the UL can be appropriately configured/indicated/activated.

### <Variations>

In the first embodiment, DL reception across the DL in the period (first period) in which unavailable resources may be configured/indicated and the DL in the period (second period) in which unavailable resources are not configured/indicated may be configured/indicated.

For example, the DL reception may be repetition transmission (repetition).

When the DL reception is configured/indicated, the UE may apply the pattern of unavailable resources only to the resources in the first period.

When the DL reception is configured/indicated, the UE may apply the pattern of unavailable resources for the DL to the resources in the first period and the resources in the second period.

When the DL reception is configured/indicated, the UE need not assume to apply the pattern of unavailable resources for the DL only to one of the resources in the first period and the resources in the second period.

In the first embodiment, the UE may assume that configuration/indication of the DL reception across the DL in the first period and the DL in the second period is not to be performed.

In the second embodiment, UL transmission across the UL in the period (first period) in which unavailable resources may be configured/indicated and the UL in the period (second period) in which unavailable resources are not configured/indicated may be configured/indicated.

For example, the UL transmission may be repetition transmission (repetition).

When the UL transmission is configured/indicated, the UE may apply the pattern of unavailable resources only to the resources in the first period.

When the UL transmission is configured/indicated, the UE may apply the pattern of unavailable resources for the UL to the resources in the first period and the resources in the second period.

When the UL transmission is configured/indicated, the UE need not assume to apply the pattern of unavailable resources for the UL only to one of the resources in the first period and the resources in the second period.

In the second embodiment, the UE may assume that configuration/indication of the UL transmission across the UL in the first period and the UL in the second period is not to be performed.

### (Radio Communication System)

Hereinafter, a structure of a radio communication system according to one embodiment of the present disclosure will be described. In this radio communication system, the radio communication method according to each embodiment of the present disclosure described above may be used alone or may be used in combination for communication.

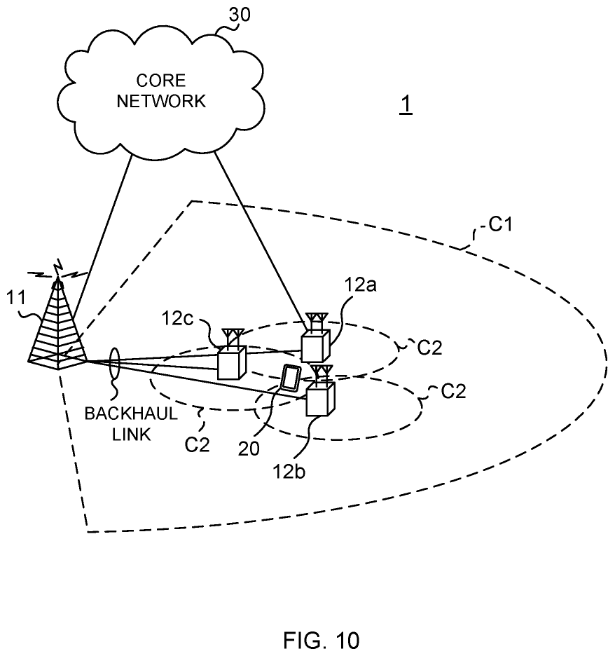

FIG. 10 is a diagram to show an example of a schematic structure of the radio communication system according to one embodiment. The radio communication system 1 may be a system implementing a communication using Long Term Evolution (LTE), 5th generation mobile communication system New Radio (5G NR) and so on the specifications of which have been drafted by Third Generation Partnership Project (3GPP).

The radio communication system 1 may support dual connectivity (multi-RAT dual connectivity (MR-DC)) between a plurality of Radio Access Technologies (RATs). The MR-DC may include dual connectivity (E-UTRA-NR Dual Connectivity (EN-DC)) between LTE (Evolved Universal Terrestrial Radio Access (E-UTRA)) and NR, dual connectivity (NR-E-UTRA Dual Connectivity (NE-DC)) between NR and LTE, and so on.

In EN-DC, a base station (eNB) of LTE (E-UTRA) is a master node (MN), and a base station (gNB) of NR is a secondary node (SN). In NE-DC, a base station (gNB) of NR is an MN, and a base station (eNB) of LTE (E-UTRA) is an SN.

The radio communication system 1 may support dual connectivity between a plurality of base stations in the same RAT (for example, dual connectivity (NR-NR Dual Connectivity (NN-DC)) where both of an MN and an SN are base stations (gNB) of NR).

The radio communication system 1 may include a base station 11 that forms a macro cell C1 of a relatively wide coverage, and base stations 12 (12a to 12c) that form small cells C2, which are placed within the macro cell C1 and which are narrower than the macro cell C1. The user terminal 20 may be located in at least one cell. The arrangement, the number, and the like of each cell and user terminal 20 are by no means limited to the aspect shown in the diagram. Hereinafter, the base stations 11 and 12 will be collectively referred to as “base stations 10,” unless specified otherwise.

The user terminal 20 may be connected to at least one of the plurality of base stations 10. The user terminal 20 may use at least one of carrier aggregation (CA) and dual connectivity (DC) using a plurality of component carriers (CCs).

Each CC may be included in at least one of a first frequency band (Frequency Range 1 (FR1)) and a second frequency band (Frequency Range 2 (FR2)). The macro cell C1 may be included in FR1, and the small cells C2 may be included in FR2. For example, FR1 may be a frequency band of 6 GHz or less (sub-6 GHz), and FR2 may be a frequency band which is higher than 24 GHz (above-24 GHz). Note that frequency bands, definitions and so on of FR1 and FR2 are by no means limited to these, and for example, FR1 may correspond to a frequency band which is higher than FR2.

The user terminal 20 may communicate using at least one of time division duplex (TDD) and frequency division duplex (FDD) in each CC.

The plurality of base stations 10 may be connected by a wired connection (for example, optical fiber in compliance with the Common Public Radio Interface (CPRI), the X2 interface and so on) or a wireless connection (for example, an NR communication). For example, if an NR communication is used as a backhaul between the base stations 11 and 12, the base station 11 corresponding to a higher station may be referred to as an “Integrated Access Backhaul (IAB) donor,” and the base station 12 corresponding to a relay station (relay) may be referred to as an “IAB node.”

The base station 10 may be connected to a core network 30 through another base station 10 or directly. For example, the core network 30 may include at least one of Evolved Packet Core (EPC), 5G Core Network (5GCN), Next Generation Core (NGC), and so on.

The user terminal 20 may be a terminal supporting at least one of communication schemes such as LTE, LTE-A, 5G, and so on.

In the radio communication system 1, an orthogonal frequency division multiplexing (OFDM)-based wireless access scheme may be used. For example, in at least one of the downlink (DL) and the uplink (UL), Cyclic Prefix OFDM (CP-OFDM), Discrete Fourier Transform Spread OFDM (DFT-s-OFDM), Orthogonal Frequency Division Multiple Access (OFDMA), Single Carrier Frequency Division Multiple Access (SC-FDMA), and so on may be used.

The wireless access scheme may be referred to as a “waveform.” Note that, in the radio communication system 1, another wireless access scheme (for example, another single carrier transmission scheme, another multi-carrier transmission scheme) may be used for a wireless access scheme in the UL and the DL.

In the radio communication system 1, a downlink shared channel (Physical Downlink Shared Channel (PDSCH)), which is used by each user terminal 20 on a shared basis, a broadcast channel (Physical Broadcast Channel (PBCH)), a downlink control channel (Physical Downlink Control Channel (PDCCH)) and so on, may be used as downlink channels.

In the radio communication system 1, an uplink shared channel (Physical Uplink Shared Channel (PUSCH)), which is used by each user terminal 20 on a shared basis, an uplink control channel (Physical Uplink Control Channel (PUCCH)), a random access channel (Physical Random Access Channel (PRACH)) and so on may be used as uplink channels.

User data, higher layer control information, System Information Blocks (SIBs) and so on are communicated on the PDSCH. User data, higher layer control information and so on may be communicated on the PUSCH. The Master Information Blocks (MIBs) may be communicated on the PBCH.

Lower layer control information may be communicated on the PDCCH. For example, the lower layer control information may include downlink control information (DCI) including scheduling information of at least one of the PDSCH and the PUSCH.

Note that DCI for scheduling the PDSCH may be referred to as “DL assignment,” “DL DCI,” and so on, and DCI for scheduling the PUSCH may be referred to as “UL grant,” “UL DCI,” and so on. Note that the PDSCH may be interpreted as “DL data”, and the PUSCH may be interpreted as “UL data”.

For detection of the PDCCH, a control resource set (CORESET) and a search space may be used. The CORESET corresponds to a resource to search DCI. The search space corresponds to a search area and a search method of PDCCH candidates. One CORESET may be associated with one or more search spaces. The UE may monitor a CORESET associated with a certain search space, based on search space configuration.

One search space may correspond to a PDCCH candidate corresponding to one or more aggregation levels. One or more search spaces may be referred to as a “search space set.” Note that a “search space,” a “search space set,” a “search space configuration,” a “search space set configuration,” a “CORESET,” a “CORESET configuration” and so on of the present disclosure may be interchangeably interpreted.

Uplink control information (UCI) including at least one of channel state information (CSI), transmission confirmation information (for example, which may be also referred to as Hybrid Automatic Repeat reQuest ACKnowledgement (HARQ-ACK), ACK/NACK, and so on), and scheduling request (SR) may be communicated by means of the PUCCH. By means of the PRACH, random access preambles for establishing connections with cells may be communicated.

Note that the downlink, the uplink, and so on in the present disclosure may be expressed without a term of “link.” In addition, various channels may be expressed without adding “Physical” to the head.

In the radio communication system 1, a synchronization signal (SS), a downlink reference signal (DL-RS), and so on may be communicated. In the radio communication system 1, a cell-specific reference signal (CRS), a channel state information-reference signal (CSI-RS), a demodulation reference signal (DMRS), a positioning reference signal (PRS), a phase tracking reference signal (PTRS), and so on may be communicated as the DL-RS.

For example, the synchronization signal may be at least one of a primary synchronization signal (PSS) and a secondary synchronization signal (SSS). A signal block including an SS (PSS, SSS) and a PBCH (and a DMRS for a PBCH) may be referred to as an “SS/PBCH block,” an “SS Block (SSB),” and so on. Note that an SS, an SSB, and so on may be also referred to as a “reference signal.”

In the radio communication system 1, a sounding reference signal (SRS), a demodulation reference signal (DMRS), and so on may be communicated as an uplink reference signal (UL-RS). Note that DMRS may be referred to as a “user terminal specific reference signal (UE-specific Reference Signal).”

### (Base Station)

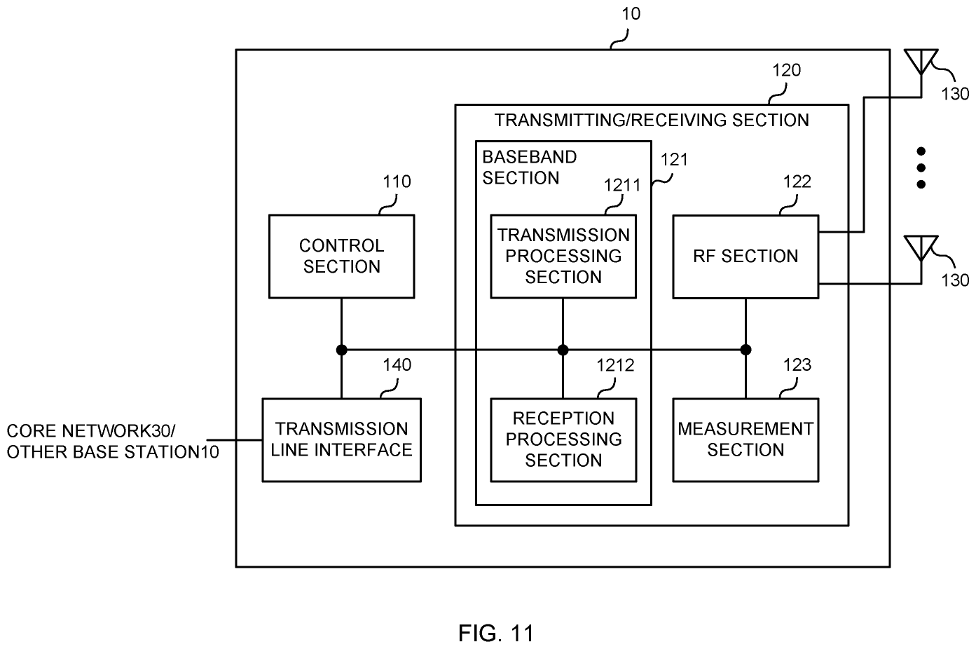

FIG. 11 is a diagram to show an example of a structure of the base station according to one embodiment. The base station 10 includes a control section 110, a transmitting/receiving section 120, transmitting/receiving antennas 130 and a communication path interface (transmission line interface) 140. Note that the base station 10 may include one or more control sections 110, one or more transmitting/receiving sections 120, one or more transmitting/receiving antennas 130, and one or more communication path interfaces 140.

Note that, the present example primarily shows functional blocks that pertain to characteristic parts of the present embodiment, and it is assumed that the base station 10 may include other functional blocks that are necessary for radio communication as well. Part of the processes of each section described below may be omitted.

The control section 110 controls the whole of the base station 10. The control section 110 can be constituted with a controller, a control circuit, or the like described based on general understanding of the technical field to which the present disclosure pertains.

The control section 110 may control generation of signals, scheduling (for example, resource allocation, mapping), and so on. The control section 110 may control transmission and reception, measurement and so on using the transmitting/receiving section 120, the transmitting/receiving antennas 130, and the communication path interface 140. The control section 110 may generate data, control information, a sequence and so on to transmit as a signal, and forward the generated items to the transmitting/receiving section 120. The control section 110 may perform call processing (setting up, releasing) for communication channels, manage the state of the base station 10, and manage the radio resources.

The transmitting/receiving section 120 may include a baseband section 121, a Radio Frequency (RF) section 122, and a measurement section 123. The baseband section 121 may include a transmission processing section 1211 and a reception processing section 1212. The transmitting/receiving section 120 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 120 may be structured as a transmitting/receiving section in one entity, or may be constituted with a transmitting section and a receiving section. The transmitting section may be constituted with the transmission processing section 1211, and the RF section 122. The receiving section may be constituted with the reception processing section 1212, the RF section 122, and the measurement section 123.

The transmitting/receiving antennas 130 can be constituted with antennas, for example, an array antenna, or the like described based on general understanding of the technical field to which the present disclosure pertains.

The transmitting/receiving section 120 may transmit the above-described downlink channel, synchronization signal, downlink reference signal, and so on. The transmitting/receiving section 120 may receive the above-described uplink channel, uplink reference signal, and so on.

The transmitting/receiving section 120 may form at least one of a transmit beam and a receive beam by using digital beam forming (for example, precoding), analog beam forming (for example, phase rotation), and so on.

The transmitting/receiving section 120 (transmission processing section 1211) may perform the processing of the Packet Data Convergence Protocol (PDCP) layer, the processing of the Radio Link Control (RLC) layer (for example, RLC retransmission control), the processing of the Medium Access Control (MAC) layer (for example, HARQ retransmission control), and so on, for example, on data and control information and so on acquired from the control section 110, and may generate bit string to transmit.

The transmitting/receiving section 120 (transmission processing section 1211) may perform transmission processing such as channel coding (which may include error correction coding), modulation, mapping, filtering, discrete Fourier transform (DFT) processing (as necessary), inverse fast Fourier transform (IFFT) processing, precoding, digital-to-analog conversion, and so on, on the bit string to transmit, and output a baseband signal.

The transmitting/receiving section 120 (RF section 122) may perform modulation to a radio frequency band, filtering, amplification, and so on, on the baseband signal, and transmit the signal of the radio frequency band through the transmitting/receiving antennas 130.

On the other hand, the transmitting/receiving section 120 (RF section 122) may perform amplification, filtering, demodulation to a baseband signal, and so on, on the signal of the radio frequency band received by the transmitting/receiving antennas 130.

The transmitting/receiving section 120 (reception processing section 1212) may apply reception processing such as analog-digital conversion, fast Fourier transform (FFT) processing, inverse discrete Fourier transform (IDFT) processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 120 (measurement section 123) may perform the measurement related to the received signal. For example, the measurement section 123 may perform Radio Resource Management (RRM) measurement, Channel State Information (CSI) measurement, and so on, based on the received signal. The measurement section 123 may measure a received power (for example, Reference Signal Received Power (RSRP)), a received quality (for example, Reference Signal Received Quality (RSRQ), a Signal to Interference plus Noise Ratio (SINR), a Signal to Noise Ratio (SNR)), a signal strength (for example, Received Signal Strength Indicator (RSSI)), channel information (for example, CSI), and so on. The measurement results may be output to the control section 110.

The communication path interface 140 may perform transmission/reception (backhaul signaling) of a signal with an apparatus included in the core network 30 or other base stations 10, and so on, and acquire or transmit user data (user plane data), control plane data, and so on for the user terminal 20.

Note that the transmitting section and the receiving section of the base station 10 in the present disclosure may be constituted with at least one of the transmitting/receiving section 120, the transmitting/receiving antennas 130, and the communication path interface 140.

The transmitting/receiving section 120 may transmit at least one of configuration information of a pattern of resources unavailable for a DL in certain time resources and indication information related to the pattern of the resources. The control section 110 may perform indication to perform DL reception in resources other than the resources unavailable for the DL, and perform indication not to perform the DL reception in the resources unavailable for the DL, using at least one of the configuration information and the indication information (first embodiment).

The transmitting/receiving section 120 may transmit at least one of configuration information of a pattern of resources unavailable for a specific type of UL transmission in certain time resources and indication information related to the pattern of the resources. The control section 110 may perform indication to perform the specific type of UL transmission in resources other than the resources unavailable for a UL, and perform indication not to perform the specific type of UL transmission in the resources unavailable for the UL, using at least one of the configuration information and the indication information (second embodiment).

### (User Terminal)

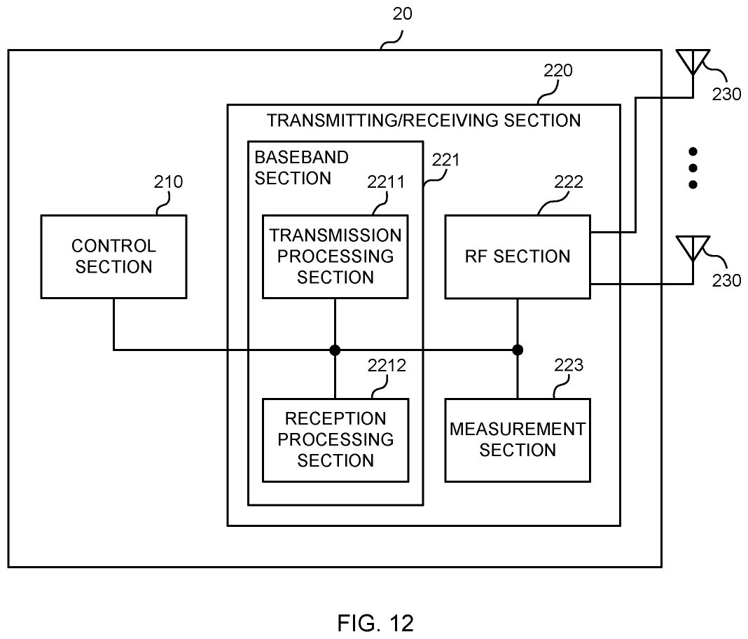

FIG. 12 is a diagram to show an example of a structure of the user terminal according to one embodiment. The user terminal 20 includes a control section 210, a transmitting/receiving section 220, and transmitting/receiving antennas 230. Note that the user terminal 20 may include one or more control sections 210, one or more transmitting/receiving sections 220, and one or more transmitting/receiving antennas 230.

Note that, the present example primarily shows functional blocks that pertain to characteristic parts of the present embodiment, and it is assumed that the user terminal 20 may include other functional blocks that are necessary for radio communication as well. Part of the processes of each section described below may be omitted.

The control section 210 controls the whole of the user terminal 20. The control section 210 can be constituted with a controller, a control circuit, or the like described based on general understanding of the technical field to which the present disclosure pertains.

The control section 210 may control generation of signals, mapping, and so on. The control section 210 may control transmission/reception, measurement and so on using the transmitting/receiving section 220, and the transmitting/receiving antennas 230. The control section 210 generates data, control information, a sequence and so on to transmit as a signal, and may forward the generated items to the transmitting/receiving section 220.

The transmitting/receiving section 220 may include a baseband section 221, an RF section 222, and a measurement section 223. The baseband section 221 may include a transmission processing section 2211 and a reception processing section 2212. The transmitting/receiving section 220 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 220 may be structured as a transmitting/receiving section in one entity, or may be constituted with a transmitting section and a receiving section. The transmitting section may be constituted with the transmission processing section 2211, and the RF section 222. The receiving section may be constituted with the reception processing section 2212, the RF section 222, and the measurement section 223.

The transmitting/receiving antennas 230 can be constituted with antennas, for example, an array antenna, or the like described based on general understanding of the technical field to which the present disclosure pertains.

The transmitting/receiving section 220 may receive the above-described downlink channel, synchronization signal, downlink reference signal, and so on. The transmitting/receiving section 220 may transmit the above-described uplink channel, uplink reference signal, and so on.

The transmitting/receiving section 220 may form at least one of a transmit beam and a receive beam by using digital beam forming (for example, precoding), analog beam forming (for example, phase rotation), and so on.

The transmitting/receiving section 220 (transmission processing section 2211) may perform the processing of the PDCP layer, the processing of the RLC layer (for example, RLC retransmission control), the processing of the MAC layer (for example, HARQ retransmission control), and so on, for example, on data and control information and so on acquired from the control section 210, and may generate bit string to transmit.

The transmitting/receiving section 220 (transmission processing section 2211) may perform transmission processing such as channel coding (which may include error correction coding), modulation, mapping, filtering, DFT processing (as necessary), IFFT processing, precoding, digital-to-analog conversion, and so on, on the bit string to transmit, and output a baseband signal.

Note that, whether to apply DFT processing or not may be based on the configuration of the transform precoding. The transmitting/receiving section 220 (transmission processing section 2211) may perform, for a certain channel (for example, PUSCH), the DFT processing as the above-described transmission processing to transmit the channel by using a DFT-s-OFDM waveform if transform precoding is enabled, and otherwise, does not need to perform the DFT processing as the above-described transmission process.

The transmitting/receiving section 220 (RF section 222) may perform modulation to a radio frequency band, filtering, amplification, and so on, on the baseband signal, and transmit the signal of the radio frequency band through the transmitting/receiving antennas 230.

On the other hand, the transmitting/receiving section 220 (RF section 222) may perform amplification, filtering, demodulation to a baseband signal, and so on, on the signal of the radio frequency band received by the transmitting/receiving antennas 230.

The transmitting/receiving section 220 (reception processing section 2212) may apply a receiving process such as analog-digital conversion, FFT processing, IDFT processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 220 (measurement section 223) may perform the measurement related to the received signal. For example, the measurement section 223 may perform RRM measurement, CSI measurement, and so on, based on the received signal. The measurement section 223 may measure a received power (for example, RSRP), a received quality (for example, RSRQ, SINR, SNR), a signal strength (for example, RSSI), channel information (for example, CSI), and so on. The measurement results may be output to the control section 210.

Note that the transmitting section and the receiving section of the user terminal 20 in the present disclosure may be constituted with at least one of the transmitting/receiving section 220 and the transmitting/receiving antennas 230.

The transmitting/receiving section 220 may receive at least one of configuration information of a pattern of resources unavailable for a DL in certain time resources and indication information related to the pattern of the resources. The control section 210 may perform control to perform DL reception in resources other than the resources unavailable for the DL, and perform control not to perform the DL reception in the resources unavailable for the DL, based on at least one of the configuration information and the indication information (first embodiment).

The certain time resources may be resources (for example, resources of the XDD part) in which the DL and an uplink may be configured in an overlapping manner in terms of time (first embodiment).

Number of bits of a parameter included in the configuration information may be equal to number of bits of the parameter included in the configuration information related to a rate match pattern of a DL shared channel (first embodiment).

The configuration information may be separately configured for each DL channel or DL signal (first embodiment).

The transmitting/receiving section 220 may receive at least one of configuration information of a pattern of resources unavailable for a specific type of UL transmission in certain time resources and indication information related to the pattern of the resources. The control section 210 may perform control to perform the specific type of UL transmission in resources other than the resources unavailable for a UL, and perform control not to perform the specific type of UL transmission in the resources unavailable for the UL, based on at least one of the configuration information and the indication information (second embodiment).

The specific type of UL transmission may be at least one of a UL shared channel, a UL control channel, a sounding reference signal, and a random access channel configured using higher layer signaling (second embodiment).

The control section may perform control to perform transmission of the UL shared channel scheduled using downlink control information in the resources unavailable for the UL (second embodiment).

The configuration information may be separately configured for each UL channel or UL signal (second embodiment).

### (Hardware Structure)

Note that the block diagrams that have been used to describe the above embodiments show blocks in functional units. These functional blocks (components) may be implemented in arbitrary combinations of at least one of hardware and software. Also, the method for implementing each functional block is not particularly limited. That is, each functional block may be realized by one piece of apparatus that is physically or logically coupled, or may be realized by directly or indirectly connecting two or more physically or logically separate pieces of apparatus (for example, via wire, wireless, or the like) and using these plurality of pieces of apparatus. The functional blocks may be implemented by combining softwares into the apparatus described above or the plurality of apparatuses described above.

Here, functions include judgment, determination, decision, calculation, computation, processing, derivation, investigation, search, confirmation, reception, transmission, output, access, resolution, selection, designation, establishment, comparison, assumption, expectation, considering, broadcasting, notifying, communicating, forwarding, configuring, reconfiguring, allocating (mapping), assigning, and the like, but function are by no means limited to these. For example, functional block (components) to implement a function of transmission may be referred to as a “transmitting section (transmitting unit),” a “transmitter,” and the like. The method for implementing each component is not particularly limited as described above.

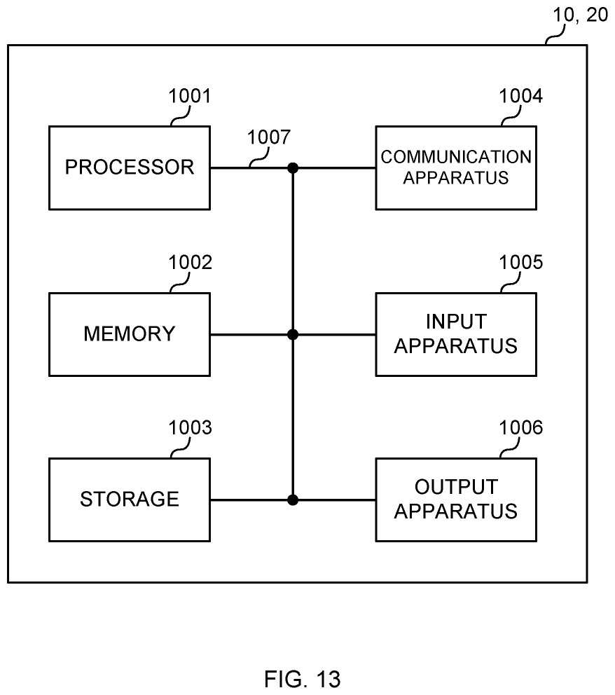

For example, a base station, a user terminal, and so on according to one embodiment of the present disclosure may function as a computer that executes the processes of the radio communication method of the present disclosure. FIG. 13 is a diagram to show an example of a hardware structure of the base station and the user terminal according to one embodiment. Physically, the above-described base station 10 and user terminal 20 may each be formed as a computer apparatus that includes a processor 1001, a memory 1002, a storage 1003, a communication apparatus 1004, an input apparatus 1005, an output apparatus 1006, a bus 1007, and so on.

Note that in the present disclosure, the words such as an apparatus, a circuit, a device, a section, a unit, and so on can be interchangeably interpreted. The hardware structure of the base station 10 and the user terminal 20 may be configured to include one or more of apparatuses shown in the drawings, or may be configured not to include part of apparatuses.

For example, although only one processor 1001 is shown, a plurality of processors may be provided. Furthermore, processes may be implemented with one processor or may be implemented at the same time, in sequence, or in different manners with two or more processors. Note that the processor 1001 may be implemented with one or more chips.

Each function of the base station 10 and the user terminals 20 is implemented, for example, by allowing certain software (programs) to be read on hardware such as the processor 1001 and the memory 1002, and by allowing the processor 1001 to perform calculations to control communication via the communication apparatus 1004 and control at least one of reading and writing of data in the memory 1002 and the storage 1003.

The processor 1001 controls the whole computer by, for example, running an operating system. The processor 1001 may be configured with a central processing unit (CPU), which includes interfaces with peripheral apparatus, control apparatus, computing apparatus, a register, and so on. For example, at least part of the above-described control section 110 (210), the transmitting/receiving section 120 (220), and so on may be implemented by the processor 1001.

Furthermore, the processor 1001 reads programs (program codes), software modules, data, and so on from at least one of the storage 1003 and the communication apparatus 1004, into the memory 1002, and executes various processes according to these. As for the programs, programs to allow computers to execute at least part of the operations of the above-described embodiments are used. For example, the control section 110 (210) may be implemented by control programs that are stored in the memory 1002 and that operate on the processor 1001, and other functional blocks may be implemented likewise.

The memory 1002 is a computer-readable recording medium, and may be constituted with, for example, at least one of a Read Only Memory (ROM), an Erasable Programmable ROM (EPROM), an Electrically EPROM (EEPROM), a Random Access Memory (RAM), and other appropriate storage media. The memory 1002 may be referred to as a “register,” a “cache,” a “main memory (primary storage apparatus)” and so on. The memory 1002 can store executable programs (program codes), software modules, and the like for implementing the radio communication method according to one embodiment of the present disclosure.

The storage 1003 is a computer-readable recording medium, and may be constituted with, for example, at least one of a flexible disk, a floppy (registered trademark) disk, a magneto-optical disk (for example, a compact disc (Compact Disc ROM (CD-ROM) and so on), a digital versatile disc, a Blu-ray (registered trademark) disk), a removable disk, a hard disk drive, a smart card, a flash memory device (for example, a card, a stick, and a key drive), a magnetic stripe, a database, a server, and other appropriate storage media. The storage 1003 may be referred to as “secondary storage apparatus.”

The communication apparatus 1004 is hardware (transmitting/receiving device) for allowing inter-computer communication via at least one of wired and wireless networks, and may be referred to as, for example, a “network device,” a “network controller,” a “network card,” a “communication module,” and so on. The communication apparatus 1004 may be configured to include a high frequency switch, a duplexer, a filter, a frequency synthesizer, and so on in order to realize, for example, at least one of frequency division duplex (FDD) and time division duplex (TDD). For example, the above-described transmitting/receiving section 120 (220), the transmitting/receiving antennas 130 (230), and so on may be implemented by the communication apparatus 1004. In the transmitting/receiving section 120 (220), the transmitting section 120a (220a) and the receiving section 120b (220b) can be implemented while being separated physically or logically.

The input apparatus 1005 is an input device that receives input from the outside (for example, a keyboard, a mouse, a microphone, a switch, a button, a sensor, and so on). The output apparatus 1006 is an output device that allows sending output to the outside (for example, a display, a speaker, a Light Emitting Diode (LED) lamp, and so on). Note that the input apparatus 1005 and the output apparatus 1006 may be provided in an integrated structure (for example, a touch panel).

Furthermore, these types of apparatus, including the processor 1001, the memory 1002, and others, are connected by a bus 1007 for communicating information. The bus 1007 may be formed with a single bus, or may be formed with buses that vary between pieces of apparatus.

Also, the base station 10 and the user terminals 20 may be structured to include hardware such as a microprocessor, a digital signal processor (DSP), an Application Specific Integrated Circuit (ASIC), a Programmable Logic Device (PLD), a Field Programmable Gate Array (FPGA), and so on, and part or all of the functional blocks may be implemented by the hardware. For example, the processor 1001 may be implemented with at least one of these pieces of hardware.

### (Variations)

Note that the terminology described in the present disclosure and the terminology that is needed to understand the present disclosure may be replaced by other terms that convey the same or similar meanings. For example, a “channel,” a “symbol,” and a “signal” (or signaling) may be interchangeably interpreted. Also, “signals” may be “messages.” A reference signal may be abbreviated as an “RS,” and may be referred to as a “pilot,” a “pilot signal,” and so on, depending on which standard applies. Furthermore, a “component carrier (CC)” may be referred to as a “cell,” a “frequency carrier,” a “carrier frequency” and so on.

A radio frame may be constituted of one or a plurality of periods (frames) in the time domain. Each of one or a plurality of periods (frames) constituting a radio frame may be referred to as a “subframe.” Furthermore, a subframe may be constituted of one or a plurality of slots in the time domain. A subframe may be a fixed time length (for example, 1 ms) independent of numerology.

Here, numerology may be a communication parameter applied to at least one of transmission and reception of a certain signal or channel. For example, numerology may indicate at least one of a subcarrier spacing (SCS), a bandwidth, a symbol length, a cyclic prefix length, a transmission time interval (TTI), the number of symbols per TTI, a radio frame structure, a particular filter processing performed by a transceiver in the frequency domain, a particular windowing processing performed by a transceiver in the time domain, and so on.

A slot may be constituted of one or a plurality of symbols in the time domain (Orthogonal Frequency Division Multiplexing (OFDM) symbols, Single Carrier Frequency Division Multiple Access (SC-FDMA) symbols, and so on). Furthermore, a slot may be a time unit based on numerology.

A slot may include a plurality of mini-slots. Each mini-slot may be constituted of one or a plurality of symbols in the time domain. A mini-slot may be referred to as a “sub-slot.” A mini-slot may be constituted of symbols less than the number of slots. A PDSCH (or PUSCH) transmitted in a time unit larger than a mini-slot may be referred to as “PDSCH (PUSCH) mapping type A.” A PDSCH (or PUSCH) transmitted using a mini-slot may be referred to as “PDSCH (PUSCH) mapping type B.”

A radio frame, a subframe, a slot, a mini-slot, and a symbol all express time units in signal communication. A radio frame, a subframe, a slot, a mini-slot, and a symbol may each be called by other applicable terms. Note that time units such as a frame, a subframe, a slot, mini-slot, and a symbol in the present disclosure may be interchangeably interpreted.

For example, one subframe may be referred to as a “TTI,” a plurality of consecutive subframes may be referred to as a “TTI,” or one slot or one mini-slot may be referred to as a “TTI.” That is, at least one of a subframe and a TTI may be a subframe (1 ms) in existing LTE, may be a shorter period than 1 ms (for example, 1 to 13 symbols), or may be a longer period than 1 ms. Note that a unit expressing TTI may be referred to as a “slot,” a “mini-slot,” and so on instead of a “subframe.”

Here, a TTI refers to the minimum time unit of scheduling in radio communication, for example. For example, in LTE systems, a base station schedules the allocation of radio resources (such as a frequency bandwidth and transmit power that are available for each user terminal) for the user terminal in TTI units. Note that the definition of TTIs is not limited to this.

TTIs may be transmission time units for channel-encoded data packets (transport blocks), code blocks, or codewords, or may be the unit of processing in scheduling, link adaptation, and so on. Note that, when TTIs are given, the time interval (for example, the number of symbols) to which transport blocks, code blocks, codewords, or the like are actually mapped may be shorter than the TTIs.

Note that, in the case where one slot or one mini-slot is referred to as a TTI, one or more TTIs (that is, one or more slots or one or more mini-slots) may be the minimum time unit of scheduling. Furthermore, the number of slots (the number of mini-slots) constituting the minimum time unit of the scheduling may be controlled.

A TTI having a time length of 1 ms may be referred to as a “normal TTI” (TTI in 3GPP Rel. 8 to Rel. 12), a “long TTI,” a “normal subframe,” a “long subframe,” a “slot” and so on. A TTI that is shorter than a normal TTI may be referred to as a “shortened TTI,” a “short TTI,” a “partial or fractional TTI,” a “shortened subframe,” a “short subframe,” a “mini-slot,” a “sub-slot,” a “slot” and so on.

Note that a long TTI (for example, a normal TTI, a subframe, and so on) may be interpreted as a TTI having a time length exceeding 1 ms, and a short TTI (for example, a shortened TTI and so on) may be interpreted as a TTI having a TTI length shorter than the TTI length of a long TTI and equal to or longer than 1 ms.

A resource block (RB) is the unit of resource allocation in the time domain and the frequency domain, and may include one or a plurality of consecutive subcarriers in the frequency domain. The number of subcarriers included in an RB may be the same regardless of numerology, and, for example, may be 12. The number of subcarriers included in an RB may be determined based on numerology.

Also, an RB may include one or a plurality of symbols in the time domain, and may be one slot, one mini-slot, one subframe, or one TTI in length. One TTI, one subframe, and so on each may be constituted of one or a plurality of resource blocks.

Note that one or a plurality of RBs may be referred to as a “physical resource block (Physical RB (PRB)),” a “sub-carrier group (SCG),” a “resource element group (REG),” a “PRB pair,” an “RB pair” and so on.

Furthermore, a resource block may be constituted of one or a plurality of resource elements (REs). For example, one RE may correspond to a radio resource field of one subcarrier and one symbol.

A bandwidth part (BWP) (which may be referred to as a “fractional bandwidth,” and so on) may represent a subset of contiguous common resource blocks (common RBs) for certain numerology in a certain carrier. Here, a common RB may be specified by an index of the RB based on the common reference point of the carrier. A PRB may be defined by a certain BWP and may be numbered in the BWP.

The BWP may include a UL BWP (BWP for the UL) and a DL BWP (BWP for the DL). One or a plurality of BWPs may be configured in one carrier for a UE.

At least one of configured BWPs may be active, and a UE does not need to assume to transmit/receive a certain signal/channel outside active BWPs. Note that a “cell,” a “carrier,” and so on in the present disclosure may be interpreted as a “BWP”.

Note that the above-described structures of radio frames, subframes, slots, mini-slots, symbols, and so on are merely examples. For example, structures such as the number of subframes included in a radio frame, the number of slots per subframe or radio frame, the number of mini-slots included in a slot, the numbers of symbols and RBs included in a slot or a mini-slot, the number of subcarriers included in an RB, the number of symbols in a TTI, the symbol length, the cyclic prefix (CP) length, and so on can be variously changed.

Also, the information, parameters, and so on described in the present disclosure may be represented in absolute values or in relative values with respect to certain values, or may be represented in another corresponding information. For example, radio resources may be specified by certain indices.

The names used for parameters and so on in the present disclosure are in no respect limiting. Furthermore, mathematical expressions that use these parameters, and so on may be different from those expressly disclosed in the present disclosure. For example, since various channels (PUCCH, PDCCH, and so on) and information elements can be identified by any suitable names, the various names allocated to these various channels and information elements are in no respect limiting.

The information, signals, and so on described in the present disclosure may be represented by using any of a variety of different technologies. For example, data, instructions, commands, information, signals, bits, symbols, chips, and so on, all of which may be referenced throughout the herein-contained description, may be represented by voltages, currents, electromagnetic waves, magnetic fields or particles, optical fields or photons, or any combination of these.

Also, information, signals, and so on can be output in at least one of from higher layers to lower layers and from lower layers to higher layers. Information, signals, and so on may be input and/or output via a plurality of network nodes.

The information, signals, and so on that are input and/or output may be stored in a specific location (for example, a memory) or may be managed by using a management table. The information, signals, and so on to be input and/or output can be overwritten, updated, or appended. The information, signals, and so on that are output may be deleted. The information, signals, and so on that are input may be transmitted to another apparatus.

Reporting of information is by no means limited to the aspects/embodiments described in the present disclosure, and other methods may be used as well. For example, reporting of information in the present disclosure may be implemented by using physical layer signaling (for example, downlink control information (DCI), uplink control information (UCI), higher layer signaling (for example, Radio Resource Control (RRC) signaling, broadcast information (master information block (MIB), system information blocks (SIBs), and so on), Medium Access Control (MAC) signaling and so on), and other signals or combinations of these.

Note that physical layer signaling may be referred to as “Layer 1/Layer 2 (L1/L2) control information (L1/L2 control signals),” “L1 control information (L1 control signal),” and so on. Also, RRC signaling may be referred to as an “RRC message,” and can be, for example, an RRC connection setup message, an RRC connection reconfiguration message, and so on. Also, MAC signaling may be reported using, for example, MAC control elements (MAC CEs).

Also, reporting of certain information (for example, reporting of “X holds”) does not necessarily have to be reported explicitly, and can be reported implicitly (by, for example, not reporting this certain information or reporting another piece of information).

Determinations may be made in values represented by one bit (0 or 1), may be made in Boolean values that represent true or false, or may be made by comparing numerical values (for example, comparison against a certain value).

Software, whether referred to as “software,” “firmware,” “middleware,” “microcode,” or “hardware description language,” or called by other terms, should be interpreted broadly to mean instructions, instruction sets, code, code segments, program codes, programs, subprograms, software modules, applications, software applications, software packages, routines, subroutines, objects, executable files, execution threads, procedures, functions, and so on.

Also, software, commands, information, and so on may be transmitted and received via communication media. For example, when software is transmitted from a website, a server, or other remote sources by using at least one of wired technologies (coaxial cables, optical fiber cables, twisted-pair cables, digital subscriber lines (DSL), and so on) and wireless technologies (infrared radiation, microwaves, and so on), at least one of these wired technologies and wireless technologies are also included in the definition of communication media.

The terms “system” and “network” used in the present disclosure can be used interchangeably. The “network” may mean an apparatus (for example, a base station) included in the network.

In the present disclosure, the terms such as “precoding,” a “precoder,” a “weight (precoding weight),” “quasi-co-location (QCL),” a “Transmission Configuration Indication state (TCI state),” a “spatial relation,” a “spatial domain filter,” a “transmit power,” “phase rotation,” an “antenna port,” an “antenna port group,” a “layer,” “the number of layers,” a “rank,” a “resource,” a “resource set,” a “resource group,” a “beam,” a “beam width,” a “beam angular degree,” an “antenna,” an “antenna element,” a “panel,” and so on can be used interchangeably.

In the present disclosure, the terms such as a “base station (BS),” a “radio base station,” a “fixed station,” a “NodeB,” an “eNB (eNodeB),” a “gNB (gNodeB),” an “access point,” a “transmission point (TP),” a “reception point (RP),” a “transmission/reception point (TRP),” a “panel,” a “cell,” a “sector,” a “cell group,” a “carrier,” a “component carrier,” a “serving cell,” and so on can be used interchangeably. The base station may be referred to as the terms such as a “macro cell,” a small cell,” a “femto cell,” a “pico cell,” and so on.

A base station can accommodate one or a plurality of (for example, three) cells. When a base station accommodates a plurality of cells, the entire coverage area of the base station can be partitioned into multiple smaller areas, and each smaller area can provide communication services through base station subsystems (for example, indoor small base stations (Remote Radio Heads (RRHs))). The term “cell” or “sector” refers to part of or the entire coverage area of at least one of a base station and a base station subsystem that provides communication services within this coverage.

In the present disclosure, the terms “mobile station (MS),” “user terminal,” “user equipment (UE),” and “terminal” may be used interchangeably.

A mobile station may be referred to as a “subscriber station,” “mobile unit,” “subscriber unit,” “wireless unit,” “remote unit,” “mobile device,” “wireless device,” “wireless communication device,” “remote device,” “mobile subscriber station,” “access terminal,” “mobile terminal,” “wireless terminal,” “remote terminal,” “handset,” “user agent,” “mobile client,” “client,” or some other appropriate terms in some cases.

At least one of a base station and a mobile station may be referred to as a “transmitting apparatus,” a “receiving apparatus,” a “radio communication apparatus,” and so on. Note that at least one of a base station and a mobile station may be device mounted on a mobile body or a mobile body itself, and so on. The mobile body may be a vehicle (for example, a car, an airplane, and the like), may be a mobile body which moves unmanned (for example, a drone, an automatic operation car, and the like), or may be a robot (a manned type or unmanned type). Note that at least one of a base station and a mobile station also includes an apparatus which does not necessarily move during communication operation. For example, at least one of a base station and a mobile station may be an Internet of Things (IoT) device such as a sensor, and the like.

Furthermore, the base station in the present disclosure may be interpreted as a user terminal. For example, each aspect/embodiment of the present disclosure may be applied to the structure that replaces a communication between a base station and a user terminal with a communication between a plurality of user terminals (for example, which may be referred to as “Device-to-Device (D2D),” “Vehicle-to-Everything (V2X),” and the like). In this case, user terminals 20 may have the functions of the base stations 10 described above. The words “uplink” and “downlink” may be interpreted as the words corresponding to the terminal-to-terminal communication (for example, “side”). For example, an uplink channel, a downlink channel and so on may be interpreted as a side channel.

Likewise, the user terminal in the present disclosure may be interpreted as base station. In this case, the base station 10 may have the functions of the user terminal 20 described above.

Actions which have been described in the present disclosure to be performed by a base station may, in some cases, be performed by upper nodes. In a network including one or a plurality of network nodes with base stations, it is clear that various operations that are performed to communicate with terminals can be performed by base stations, one or more network nodes (for example, Mobility Management Entities (MMEs), Serving-Gateways (S-GWs), and so on may be possible, but these are not limiting) other than base stations, or combinations of these.

The aspects/embodiments illustrated in the present disclosure may be used individually or in combinations, which may be switched depending on the mode of implementation. The order of processes, sequences, flowcharts, and so on that have been used to describe the aspects/embodiments in the present disclosure may be re-ordered as long as inconsistencies do not arise. For example, although various methods have been illustrated in the present disclosure with various components of steps in exemplary orders, the specific orders that are illustrated herein are by no means limiting.

The aspects/embodiments illustrated in the present disclosure may be applied to Long Term Evolution (LTE), LTE-Advanced (LTE-A), LTE-Beyond (LTE-B), SUPER 3G, IMT-Advanced, 4th generation mobile communication system (4G), 5th generation mobile communication system (5G), 6th generation mobile communication system (6G), xth generation mobile communication system (xG) (xG (where x is, for example, an integer or a decimal)), Future Radio Access (FRA), New-Radio Access Technology (RAT), New Radio (NR), New radio access (NX), Future generation radio access (FX), Global System for Mobile communications (GSM (registered trademark)), CDMA 2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), systems that use other adequate radio communication methods and next-generation systems that are enhanced based on these. A plurality of systems may be combined (for example, a combination of LTE or LTE-A and 5G, and the like) and applied.

The phrase “based on” (or “on the basis of”) as used in the present disclosure does not mean “based only on” (or “only on the basis of”), unless otherwise specified. In other words, the phrase “based on” (or “on the basis of”) means both “based only on” and “based at least on” (“only on the basis of” and “at least on the basis of”).

Reference to elements with designations such as “first,” “second,” and so on as used in the present disclosure does not generally limit the quantity or order of these elements. These designations may be used in the present disclosure only for convenience, as a method for distinguishing between two or more elements. Thus, reference to the first and second elements does not imply that only two elements may be employed, or that the first element must precede the second element in some way.

The term “judging (determining)” as in the present disclosure herein may encompass a wide variety of actions. For example, “judging (determining)” may be interpreted to mean making “judgments (determinations)” about judging, calculating, computing, processing, deriving, investigating, looking up, search and inquiry (for example, searching a table, a database, or some other data structures), ascertaining, and so on.

Furthermore, “judging (determining)” may be interpreted to mean making “judgments (determinations)” about receiving (for example, receiving information), transmitting (for example, transmitting information), input, output, accessing (for example, accessing data in a memory), and so on.

In addition, “judging (determining)” as used herein may be interpreted to mean making “judgments (determinations)” about resolving, selecting, choosing, establishing, comparing, and so on. In other words, “judging (determining)” may be interpreted to mean making “judgments (determinations)” about some action.

In addition, “judging (determining)” may be interpreted as “assuming,” “expecting,” “considering,” and the like.

The terms “connected” and “coupled,” or any variation of these terms as used in the present disclosure mean all direct or indirect connections or coupling between two or more elements, and may include the presence of one or more intermediate elements between two elements that are “connected” or “coupled” to each other. The coupling or connection between the elements may be physical, logical, or a combination thereof. For example, “connection” may be interpreted as “access.”

In the present disclosure, when two elements are connected, the two elements may be considered “connected” or “coupled” to each other by using one or more electrical wires, cables and printed electrical connections, and, as some non-limiting and non-inclusive examples, by using electromagnetic energy having wavelengths in radio frequency regions, microwave regions, (both visible and invisible) optical regions, or the like.

In the present disclosure, the phrase “A and B are different” may mean that “A and B are different from each other.” Note that the phrase may mean that “A and B is each different from C.” The terms “separate,” “be coupled,” and so on may be interpreted similarly to “different.”

When terms such as “include,” “including,” and variations of these are used in the present disclosure, these terms are intended to be inclusive, in a manner similar to the way the term “comprising” is used. Furthermore, the term “or” as used in the present disclosure is intended to be not an exclusive disjunction.

For example, in the present disclosure, when an article such as “a,” “an,” and “the” in the English language is added by translation, the present disclosure may include that a noun after these articles is in a plural form.

Now, although the invention according to the present disclosure has been described in detail above, it should be obvious to a person skilled in the art that the invention according to the present disclosure is by no means limited to the embodiments described in the present disclosure. The invention according to the present disclosure can be implemented with various corrections and in various modifications, without departing from the spirit and scope of the invention defined by the recitations of claims. Consequently, the description of the present disclosure is provided only for the purpose of explaining examples, and should by no means be construed to limit the invention according to the present disclosure in any way.

1. A terminal comprising:
a receiving section that receives at least one of configuration information of a pattern of resources unavailable for a DL in certain time resources and indication information related to the pattern of the resources; and
a control section that performs control to perform DL reception in resources other than the resources unavailable for the DL, and performs control not to perform the DL reception in the resources unavailable for the DL, based on at least one of the configuration information and the indication information.

2. The terminal according to claim 1, wherein
the certain time resources are resources in which the DL and an uplink may be configured in an overlapping manner in terms of time.

3. The terminal according to claim 1, wherein
number of bits of a parameter included in the configuration information is equal to number of bits of the parameter included in the configuration information related to a rate match pattern of a DL shared channel.

4. The terminal according to claim 1, wherein
the configuration information is separately configured for each DL channel or DL signal.

5. A radio communication method for a terminal, the radio communication method comprising:
receiving at least one of configuration information of a pattern of resources unavailable for a DL in certain time resources and indication information related to the pattern of the resources; and
performing control to perform DL reception in resources other than the resources unavailable for the DL, and performing control not to perform the DL reception in the resources unavailable for the DL, based on at least one of the configuration information and the indication information.

6. A base station comprising:
a transmitting section that transmits at least one of configuration information of a pattern of resources unavailable for a DL in certain time resources and indication information related to the pattern of the resources; and
a control section that performs indication to perform DL reception in resources other than the resources unavailable for the DL, and performs indication not to perform the DL reception in the resources unavailable for the DL, using at least one of the configuration information and the indication information.
